(19) United States
(12) Patent Application Publication
(10) Pub. No.: US 2023/0307636 A1
(43) Pub. Date: Sep. 28, 2023

(54) ACTIVE MATERIAL PARTICLE, ANODE, SECONDARY BATTERY, AND METHOD FOR PRODUCING ACTIVE MATERIAL PARTICLE

(71) Applicant: CANON KABUSHIKI KAISHA, Tokyo (JP)

(72) Inventors: KENTA KUBO, Kanagawa (JP); HIROKAZU USAMI, Kanagawa (JP); HIROSHI TANIUCHI, Kanagawa (JP); TAKAHARU AOTANI, Tokyo (JP)

(21) Appl. No.: 18/325,557

(22) Filed: May 30, 2023

Related U.S. Application Data
(63) Continuation of application No. PCT/JP2021/043088, filed on Nov. 25, 2021.

(30) Foreign Application Priority Data
Dec. 2, 2020 (JP) 2020-200600
Dec. 2, 2020 (JP) 2020-200601

(51) Int. Cl. H01M 4/525; H01M 4/04; H01M 10/058; H01M 4/131; H01M 10/052; C01G 51/00

(52) U.S. Cl. CPC H01M 4/525; H01M 4/0471; H01M 10/058; H01M 4/131; H01M 10/052; C01G 51/42; H01M 2004/027

(57) ABSTRACT

An active material particle or anode containing a lithium cobalt oxide and having a diffraction angle peak at an X-ray diffraction angle of 19.2 degrees or more and 19.7 degrees or less by a 2θ method.

### CROSS-REFERENCE TO RELATED APPLICATIONS

This application is a Continuation of International Patent Application No. PCT/JP2021/043088, filed Nov. 25, 2021, which claims the benefit of Japanese Patent Application No. 2020-200600, filed Dec. 2, 2020 and Japanese Patent Application No. 2020-200601, filed Dec. 2, 2020, all of which are hereby incorporated by reference herein in their entirety.

### TECHNICAL FIELD

The present invention relates to an active material particle, a anode, a secondary battery, and a method for producing an active material particle.

### BACKGROUND ART

In general, a secondary battery is composed of electrodes (a anode and a cathode) and an electrolyte and is charged and discharged by ion migration between the electrodes through the electrolyte. Such a secondary battery is used in a wide range of applications from small devices, such as mobile phones, to large devices, such as electric vehicles. Thus, there is a need for further improvement of the performance of a secondary battery. To improve the charge-discharge characteristics of a secondary battery, it is generally important to enlarge the interface between an active material of an electrode and an electrolyte. The active material is a material that is involved in a reaction that generates electricity.

To improve the charge-discharge characteristics, a method of using an active material with a fine protrusion in a anode of a solid-state secondary battery is known as a specific measure. Japanese Patent Laid-Open No. 2015-220080 discloses a technique of providing, on a current collector, a lithium cobalt oxide pattern with a specific surface area increased to 1.1 to 2 by a flux method, which includes bringing a plating layer containing cobalt into contact with a raw material of an active material containing lithium and heating the plating layer and the active material. Japanese Patent Laid-Open No. 2015-220080 discloses that it is possible to utilize a space between active material particles formed by a protrusion to provide a transport path of an active material ion through which the active material enters a anode.

The method for forming an active material layer with a specific surface area increased by the flux method disclosed in Japanese Patent Laid-Open No. 2015-220080 has a structural restriction due to a monolayer structure supported by a metal layer on the current collector side, and limits the improvement of the design and characteristics of a secondary battery. The method for forming an active material layer with a specific surface area increased by the flux method disclosed in Japanese Patent Laid-Open No. 2015-220080 requires heating a contact portion between a metal in the plating layer and an active material containing Li in the temperature range of 500° C. to 1000° C.

Thus, a process of producing a secondary battery sometimes requires high heat resistance of another element constituting the secondary battery, or there is an expectation for a method substituting for the flux method to speed up the production process and reduce energy consumption.

It is an object of the present invention to provide an active material particle that can be produced at a lower temperature in a battery production process and that can be used for a anode with high ionic conductivity. It is another object of the present invention to provide a secondary battery with good charge-discharge characteristics through a low-temperature production process by using an active material particle that does not excessively require high heat resistance.

In a lithium cobalt oxide with a protrusion produced by the method disclosed in Japanese Patent Laid-Open No. 2015-220080, a protrusion of a anode active material was sometimes insufficiently developed. A lithium cobalt oxide with a protrusion produced by the method disclosed in Japanese Patent Laid-Open No. 2015-220080 has the problem of low flexibility in the arrangement of an electrolyte material in the layer thickness direction. It is an object of the present application to provide a anode with high ionic conductivity due to a reduced ion migration barrier between a anode active material and an electrolyte and with ensured flexibility in the arrangement of the anode active material, and to provide a secondary battery including the anode.

### CITATION LIST

### Patent Literature

PTL 1 Japanese Patent Laid-Open No. 2015-220080

### SUMMARY OF INVENTION

An active material particle according to an embodiment of the present invention is an active material particle to be applied to a anode containing a lithium cobalt oxide and has a diffraction angle peak at an X-ray diffraction angle of 19.2 degrees or more and 19.7 degrees or less by a 2θ method.

Furthermore, an active material particle according to an embodiment of the present invention is an active material particle to be applied to a anode containing a lithium cobalt oxide and has a region with a crystallite size of 1 nm or more and 50 nm or less.

A method for producing an active material particle according to an embodiment of the present invention includes a first heating step of reducing at least part of cobalt contained in the active material particle and a second heating step of oxidizing the reduced cobalt.

A anode according to an embodiment of the present invention is a anode to be applied to a secondary battery containing an active material particle containing a lithium cobalt oxide, and the active material particle has a diffraction angle peak at an X-ray diffraction angle in the range of 19.2 to 19.7 degrees by the 2θ method.

A anode according to an embodiment of the present invention is a anode to be applied to a secondary battery containing an active material particle containing a lithium cobalt oxide and has a region in which the active material particle has a crystallite size of 10 nm or more and 50 nm or less.

A method for producing a anode according to an embodiment of the present invention includes an arrangement step of arranging active material particles containing a lithium cobalt oxide on a predetermined surface, a first heating step of reducing at least part of cobalt contained in the active material particles, and a second heating step of oxidizing the reduced cobalt.

Further features of the present invention will become apparent from the following description of exemplary embodiments with reference to the attached drawings.

### BRIEF DESCRIPTION OF DRAWINGS

FIG. 1A is a schematic cross-sectional view of an active material particle according to a first embodiment.

FIG. 1B is an X-ray diffraction profile of the active material particle according to the first embodiment.

FIG. 1C is a schematic cross-sectional view of an active material particle according to a reference embodiment of the active material particle according to the first embodiment.

FIG. 1D is an X-ray diffraction profile of the active material particle according to the reference embodiment of the active material particle according to the first embodiment.

FIG. 2A is a SEM image of the appearance of the active material particle according to the first embodiment.

FIG. 2B is a cross-sectional TEM image of the active material particle according to the first embodiment.

FIG. 2C is a cross-sectional TEM image of a reference embodiment of the active material particle according to the first embodiment.

FIG. 3A is a schematic cross-sectional view of a secondary battery according to the first embodiment.

FIG. 3B is a schematic cross-sectional view of a anode of the secondary battery according to the first embodiment.

FIG. 4 is a flow chart of a method for producing the secondary battery according to the first embodiment.

FIG. 5A is a flow chart of production steps of the active material particle according to the first embodiment.

FIG. 5B is an example of a temperature profile of the active material particle according to the first embodiment.

FIG. 6 is an estimated change in a fine particle cross-sectional structure through production steps of the active material particle according to the first embodiment.

FIG. 7A is a differential thermogravimetric analysis result of a resin according to the first embodiment.

FIG. 7B is a differential thermogravimetric analysis result of a laminate according to the first embodiment.

FIG. 7C is an explanatory view of a thermal decomposition temperature based on thermogravimetric analysis according to the first embodiment.

FIG. 8A is a SEM image showing the results of examining the dependency of an active material particle and a resin on the heating atmosphere in an air atmosphere.

FIG. 8B is a SEM image showing the results of examining the dependency of an active material particle and a resin on the heating atmosphere in an air atmosphere.

FIG. 8C is a SEM image showing the results of examining the dependency of an active material particle and a resin on the heating atmosphere in an air atmosphere.

FIG. 8D is a SEM image showing the results of examining the dependency of an active material particle and a resin on the heating atmosphere in an air atmosphere.

FIG. 8E is a SEM image showing the results of examining the dependency of an active material particle and a resin on the heating atmosphere in an air atmosphere.

FIG. 9A is a schematic view of a preparation step according to the first embodiment.

FIG. 9B is a schematic view of an arrangement step according to the first embodiment.

FIG. 9C is a schematic view of a modified example of the preparation step according to the first embodiment.

FIG. 9D is a schematic view of a modified example of the preparation step according to the first embodiment.

FIG. 10A is a flow chart of a method for producing a anode according to a second embodiment.

FIG. 10B is a schematic cross-sectional view of the anode according to the second embodiment.

FIG. 10C is a flow chart of a modified example of the method for producing the anode according to the second embodiment.

FIG. 10D is a schematic cross-sectional view of a modified example of the anode according to the second embodiment.

FIG. 11A is a schematic cross-sectional view of a secondary battery according to a third embodiment.

FIG. 11B is a schematic cross-sectional view of a anode of the secondary battery according to the third embodiment.

FIG. 11C is an X-ray diffraction profile of an active material particle of the secondary battery according to the third embodiment.

FIG. 11D is an X-ray diffraction profile of a reference embodiment of the secondary battery according to the third embodiment.

FIG. 12A is a SEM image of a cross section of the anode according to the third embodiment.

FIG. 12B is a SEM image of an upper surface of the anode according to the third embodiment.

FIG. 12C is a SEM image of the appearance of a anode active material according to the third embodiment.

FIG. 12D is a cross-sectional TEM image of the appearance of a anode active material according to the third embodiment.

FIG. 13A is a cross-sectional TEM image corresponding to a boundary region between a particle portion and a protrusion of an active material particle according to the third embodiment.

FIG. 13B is a cross-sectional TEM image corresponding to a particle portion and a protrusion of the active material particle according to the third embodiment.

FIG. 14A is a flow chart of the production sequence of the anode according to the third embodiment.

FIG. 14B is an example of a temperature profile of the anode according to the third embodiment.

FIG. 14C is an estimated modification mechanism of the active material particle according to the third embodiment.

FIG. 15A is a differential thermogravimetric analysis result of a resin according to the third embodiment.

FIG. 15B is a differential thermogravimetric analysis result of a laminate according to the third embodiment.

FIG. 15C is an explanatory view of a thermal decomposition temperature based on thermogravimetric analysis of the resin and laminate according to the third embodiment.

FIG. 16A is a cross-sectional SEM image of an active material particle at 300° C. indicating a difference in a first heating temperature of the laminate according to the third embodiment.

FIG. 16B is a cross-sectional SEM image of an active material particle at 400° C. indicating a difference in the first heating temperature of the laminate according to the third embodiment.

FIG. 16C is a cross-sectional SEM image of an active material particle at 500° C. indicating a difference in the first heating temperature of the laminate according to the third embodiment.

FIG. 17A is a cross-sectional SEM image of the laminate according to the third embodiment before and after a first heating step.

FIG. 17B is a cross-sectional SEM image of the anode of the laminate according to the third embodiment before and after the first heating step.

FIG. 17C is a cross-sectional SEM image of the laminate according to the third embodiment before and after a second heating step.

FIG. 17D is a cross-sectional SEM image of the anode of the laminate according to the third embodiment before and after the second heating step.

FIG. 18A is a flow chart of a method for producing a secondary battery according to a fourth embodiment.

FIG. 18B is a modified example of the flow chart of the method for producing the secondary battery according to the fourth embodiment.

FIG. 18C is a modified example of the flow chart of the method for producing the secondary battery according to the fourth embodiment.

FIG. 19A is an estimated change in atmosphere in each step according to a fifth embodiment.

FIG. 19B is an estimated change in atmosphere in each step according to a reference embodiment of the fifth embodiment.

FIG. 19C is an estimated change in atmosphere in each step according to a reference embodiment of the fifth embodiment.

FIG. 20A is a schematic cross-sectional view of a anode according to the fourth embodiment.

FIG. 20B is a schematic cross-sectional view of a anode according to a modified embodiment of the fourth embodiment.

FIG. 21 is a schematic view of a secondary battery forming process according to Example 1.

FIG. 22 is a schematic view of a method for patterning an active material particle and an electrolyte particle according to Example 1.

FIG. 23 is SEM images of arrangement patterns A and B of the active material particle and a anode internal electrolyte (first particle) according to Example 1.

FIG. 24A is a schematic view of a sample according to Example 1.

FIG. 24B is a SEM image of a sample according to Example 1 before and after degreasing.

FIG. 25 is a TG-DTA measurement result of a PET substrate according to Example 1.

FIG. 26 is a SEM image of a sample corresponding to the degreasing conditions of a reference example of Example 1.

FIG. 27A is SEM images comparing arrangement patterns A and B of an active material particle LCO of a prototype secondary battery according to Example 1.

FIG. 27B is a charge-discharge measurement result corresponding to the SEM images comparing the arrangement patterns A and B of the active material particle LCO of the prototype secondary battery according to Example 1.

FIG. 28 is an impedance measurement result of comparing the arrangement patterns A and B of the active material particle LCO of the prototype secondary battery according to Example 1.

FIG. 29A is an arrangement pattern of a anode active material particle of a anode active material layer and a anode internal electrolyte particle in Example 1.

FIG. 29B is a charge-discharge measurement result of a secondary battery with the anode active material layer according to Example 1.

### DESCRIPTION OF EMBODIMENTS

Preferred embodiments of the present invention are described in detail below with reference to the drawings. The dimensions, materials, shapes, and relative arrangements of the constituents described in these embodiments are not intended to limit the scope of the present invention.

### First Embodiment

<Microscopic Structure of Active Material Particle>

On the basis of study results by the present inventors, it has been found that the charge-discharge and characteristics of a secondary battery, which have been limited due to a high transfer barrier of an active material ion between an active material particle and an electrolyte, can be improved by using a metastable lithium cobalt oxide as a predetermined electrolyte particle. More specifically, the present inventors have found that, to increase the conductivity of an active material ion, it is preferable to use a metastable lithium cobalt oxide in which the crystal structure of an active material particle is different from that of a stable lithium cobalt oxide.

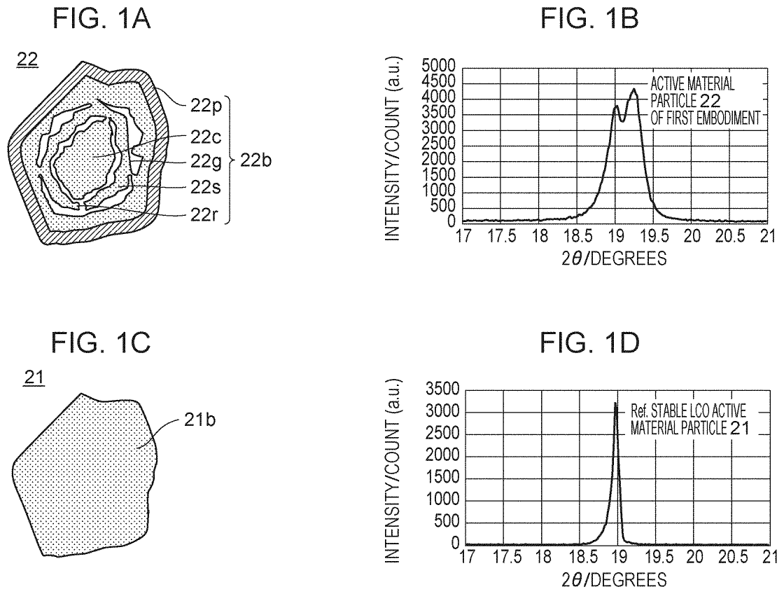

Next, an active material particle 22 according to a first embodiment containing a metastable lithium cobalt oxide of the present embodiment is described with reference to FIG. 1A. For comparison with the active material particle 22, an active material particle 21 containing a stable lithium cobalt oxide according to a reference embodiment is described with reference to FIG. 1C. FIG. 1A is a schematic cross-sectional view of the active material particle 22 according to the first embodiment. FIG. 1B is an X-ray diffraction profile of the active material particle 22. FIG. 1C is a schematic cross-sectional view of the active material particle 21 according to the reference embodiment. FIG. 1D is an X-ray diffraction profile of the active material particle 21.

As illustrated in FIG. 1A, the active material particle 22 has a particle portion 22b and protrusions 22p protruding radially in a plurality of directions on the outer surface of the particle portion 22b. In the active material particle 22, as illustrated in FIG. 1A, the inside of the particle portion 22b has a core-shell-like discontinuous texture including a core 22c, a plurality of layered voids 22g, a plurality of shells 22s, and a radial void 22r. The particle portion 22b has an increased specific surface area and is porous in both the inside and the outside thereof, and is different in this point from the active material particle 21 containing the stable lithium cobalt oxide and having a plain cross-sectional structure illustrated in FIG. 1C. In other words, the active material particle 21 containing the stable lithium cobalt oxide is not subjected to first and second heating steps described later and has a particle cross section with a homogeneous and continuous texture.

<Crystal Structure of Active Material Particle>

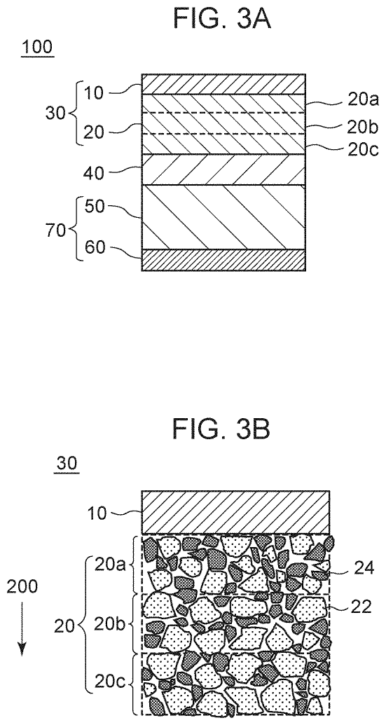

FIG. 1B is a diffraction angle profile by the 2θ method of a powder sample prepared by collecting a plurality of the active material particles 22 illustrated in FIG. 1A, measured by X-ray diffractometry (hereinafter sometimes referred to as an XRD method). Such a powder sample can be prepared by disassembling a anode 30 illustrated in FIG. 3B described later. As shown in FIG. 1B, the X-ray diffraction angle profile is a bimodal XRD profile with at least two diffraction angle peaks at 18.9 degrees or more and 19.1 degrees or less and at 19.2 degrees or more and 19.7 degrees or less in the X-ray diffraction angle range of 18 degrees to 20 degrees. On the other hand, it is known that a stable lithium cobalt oxide has a unimodal XRD profile with one diffraction angle peak in the range of 18.9 degrees to 19.1 degrees.

More specifically, the diffraction angle peak on the low angle side of the active material particle 22 observed at a diffraction angle of 18.9 degrees or more and 19.1 degrees or less is an overlapping diffraction angle peak of 18.99 degrees and 19.03 degrees. For the sake of simplicity, the diffraction angle peak on the low angle side is represented by the diffraction angle peak with the highest intensity at 19.03 degrees. The diffraction angle peak of the active material particle 22 at 19.03 degrees had a half-width of 0.28 degrees. The diffraction angle peak on the high angle side of the active material particle 22 observed at a diffraction angle of 19.2 degrees or more and 19.7 degrees or less is also an overlapping diffraction angle peak. For the sake of simplicity, the diffraction angle peak on the high angle side is represented by the diffraction angle peak with the highest intensity at 19.25 degrees. More specifically, the diffraction angle peak on the high angle side of the active material particle 22 is an overlapping diffraction angle peak of a plurality of diffraction angle peaks at 19.17 degrees, 19.21 degrees, 19.25 degrees, and 19.29 degrees. The diffraction angle peak of the active material particle 22 at 19.25 degrees had a half-width of 0.26 degrees. The crystallite sizes φgc of crystal structures corresponding to the diffraction angle peaks of the active material particle 22 at 19.03 degrees and 19.25 degrees were 28.8 nm and 31.0 nm, respectively, from the Scherrer equation of the general formula (1).

Scherrer equation: τ=Kλ/(βcos θ) formula (1)

The parameters in the formula (1) are τ: crystallite size, K: form factor (0.9), λ: X-ray wavelength, β: half-width of diffraction angle peak, and θ: Bragg angle.

As a reference embodiment, FIG. 1D shows an XRD profile of a lithium cobalt oxide sold as a commercial product including a diffraction angle 2θ in the range of approximately 18 to 20 degrees. The active material particle 21 containing a stable LCO according to the reference embodiment is a virgin commercial product (registered trademark CELLSEED manufactured by Nippon Chemical Industrial Co., Ltd.) not subjected to the first heating step and the second heating step described later. It can be seen that the active material particle 21 containing the stable LCO has a single peak at 18.95 degrees, which is slightly lower than 19 degrees. The crystallite size φgc of a crystal structure corresponding to the diffraction angle peak of the active material particle 21 at 18.95 degrees was 89.6 nm from the Scherrer equation of the formula (1). The diffraction angle peak at a diffraction angle 2θ of approximately 19 degrees in the X-ray diffraction angle range of 18 degrees to 20 degrees corresponds to a (003) plane of a lithium cobalt oxide crystal.

The active material particle 22 according to the present embodiment has a characteristic broad high-angle diffraction angle peak at 19.2 degrees or more and 19.7 degrees or less, which is not observed in the active material particle 21 containing the stable lithium cobalt oxide. In other words, the active material particle 22 according to the present embodiment has a plurality of diffraction angle peaks at X-ray diffraction angles of 19.2 degrees or more and 19.7 degrees or less by the 2θ method. In other words, the active material particle 22 according to the present embodiment has a high-angle diffraction angle peak at an X-ray diffraction angle of 19.2 degrees or more and 19.7 degrees or less and a low-angle diffraction angle peak at an X-ray diffraction angle of 18.9 degrees or more and 19.1 degrees or less by the 2θ method.

The active material particle 22 according to the present embodiment has a plurality of characteristic peaks (19.17 degrees, 19.21 degrees, 19.25 degrees, and 19.29 degrees) splitting on a higher angle side than a stable lithium cobalt oxide. The plurality of diffraction angle peaks show that the active material particle 22 has a plurality of crystal structures with a distribution in lattice spacing and crystallite size. The plurality of diffraction angle peaks also show that the active material particle 22 has a plurality of crystal structures with a smaller lattice spacing and a smaller crystallite size than the stable active material particle 21. In other words, a plurality of crystal structures with a smaller lattice spacing and a smaller crystallite size than the stable active material particle 21 are mixed in the active material particle 22.

Thus, it can be shown that the crystallite size of the active material particle 22 in the anode 30 according to the present embodiment is smaller than the crystallite size of the stable active material particle 21. It is thought that the active material particle 22 has a plurality of crystallites with different crystallite sizes of 10 nm or more and 50 nm or less in consideration of the distribution of diffraction angle peaks at a diffraction angle of 19.2 degrees or more and 19.7 degrees or less.

Next, the lattice constant of the crystal structure of the active material particle 22 according to the present embodiment is described below. The angle 2θ of a diffraction angle peak and the Bragg equation of the following formula (2) were used to determine the lattice constant c of the active material particle 22 at a diffraction angle peak of 19.03 degrees and 19.25 degrees. The lattice constants c of the active material particle 22 at a diffraction angle peak of 19.03 degrees and 19.25 degrees were 1.40 nm and 1.38 nm, respectively.

On the other hand, the diffraction angle peak of the active material particle 21 containing the stable lithium cobalt oxide at 18.95 degrees had a lattice constant c of 1.40 nm. This shows that the interplanar spacing of the active material particle 22 according to the present embodiment has a portion slightly narrower than the interplanar spacing of the stable active material particle 21.

Bragg equation: c²=λ²(h²+k²+l²)/(4 sin²θ) formula (2)

In the formula (2), θ denotes a Bragg angle, λ denotes an X-ray wavelength, and h, k, and l (integers) denote Miller indices.

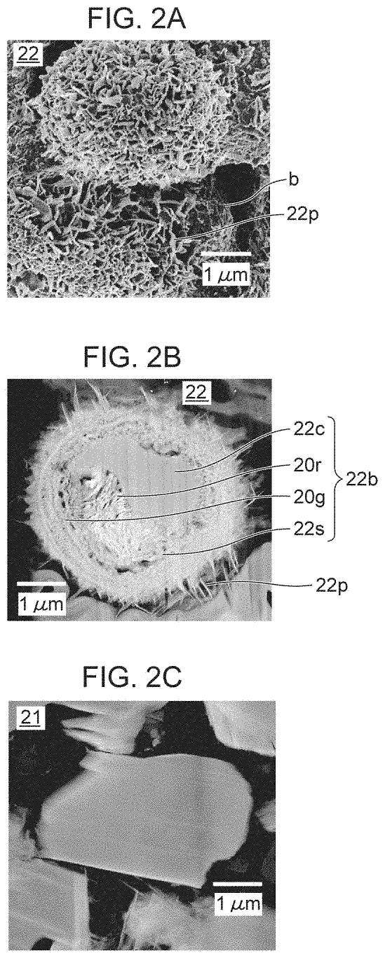

Next, a microscopic structure of the active material particle 22 in the anode 30 according to the present embodiment is described with reference to micrographs shown in FIGS. 2A and 2B. FIG. 2A is a SEM image showing the appearance of the active material particle according to the first embodiment. FIG. 2B is a cross-sectional TEM image showing the appearance of the active material particle according to the first embodiment. FIG. 2C is a cross-sectional TEM image of the active material particle of the reference embodiment.

The active material particle 22 of FIGS. 2A and 2B correspond to the active material particle 22 of FIGS. 1A and 1B. As shown in FIGS. 2A and 2B, the active material particle 22 according to the present embodiment has a particle portion 22b and protrusions 22p protruding radially in a plurality of directions on the outer surface of the particle portion 22b. It is thought that, in the active material particle 22 on the lower side in FIG. 2A, in the process of preparing a sample for SEM from a sintered body of the active material particle 22 formed by a method described later, protrusions 22p on the right side of the active material particle 22 in FIG. 2A partially fall off, and the surface of the particle portion 22b is exposed.

In the active material particle 22, as shown in FIG. 2B, the inside of the particle portion 22b has a core-shell-like discontinuous texture including a core 22c, a plurality of layered voids 20g, a plurality of shells 22s, and a radial void 20r. The active material particle 22 has an increased specific surface area and is porous in both the inside and the outside thereof, and is different in this point from the active material particle 21 containing the stable lithium cobalt oxide and having a plain cross-sectional structure illustrated in FIG. 2C.

The SEM image of FIG. 2A is a backscattered electron image acquired at an accelerating voltage of 6 kV and at a magnification of 12k. The cross-sectional TEM image of FIG. 2B was acquired in a sample with a slice thickness in the range of 100 to 150 μm at an accelerating voltage of 300 kV.

It is thought that the active material particle 22 according to the present embodiment has the protrusions 22p having a surface with an increased specific surface area and protruding in a plurality of directions, has therefore an increased probability of contact with an electrolyte, and easily transfers an active material ion to and from the electrolyte.

A cross-sectional TEM image of the active material particle 22 according to the present embodiment was acquired as a lattice image (not shown). The lattice image by the cross-sectional TEM was acquired by photographing a sample with a slice thickness in the range of 100 to 150 μm at an accelerating voltage of 200 kV or 300 kV. The sliced sample was prepared with an ion milling apparatus (manufactured by Leica) capable of FIB processing. Like the SEM image of FIG. 2A, the acquired cross-sectional TEM image shows a plurality of protrusions from the particle portion. Furthermore, a striped pattern corresponding to the c-axis orientation of the crystal structure of the protrusions was observed. The striped pattern showed the distribution of a plurality of crystallites with the c-axis tilted by a predetermined angle with respect to the axial direction of the protrusions. The plurality of crystallite sizes were distributed in the range of 1 nm or more and 20 nm or less. The crystallite size was determined as a diameter by identifying the region of the striped pattern aligned in a characteristic direction of the protrusions and fitting the boundary into a circle. A crystallite may also be referred to as a single crystal domain.

On the other hand, the crystallite size determined from a lattice image of cross-sectional TEM of the active material particle 21, which is a virgin commercial product not subjected to the first heating step and the second heating step described later, was 90 nm, which was larger than the crystallite size of the active material particle 22. As described above, regarding the crystallinity of the active material particle 22 according to the present embodiment and the stable active material particle 21 according to the reference embodiment, the result of the X-ray diffractometry and the result of the lattice image of the cross-sectional TEM method were consistent with each other. Both the result of the X-ray diffractometry and the result of the lattice image of the cross-sectional TEM method showed that the active material particle 22 had a smaller crystallite size than the active material particle 21. Both the result of the X-ray diffractometry and the result of the lattice image of the cross-sectional TEM method also showed that the active material particle 22 had a larger variation in crystallite size than the active material particle 21. It is assumed that the active material particle 22 according to the present embodiment is a metastable lithium cobalt oxide in a metastable state.

It is thought that the diffusion coefficient of a Li ion in an active material particle depends on the crystallite size of a lithium cobalt oxide, the distribution of the crystallite orientation, and the specific surface area corresponding to the effective reaction area of the active material particle.

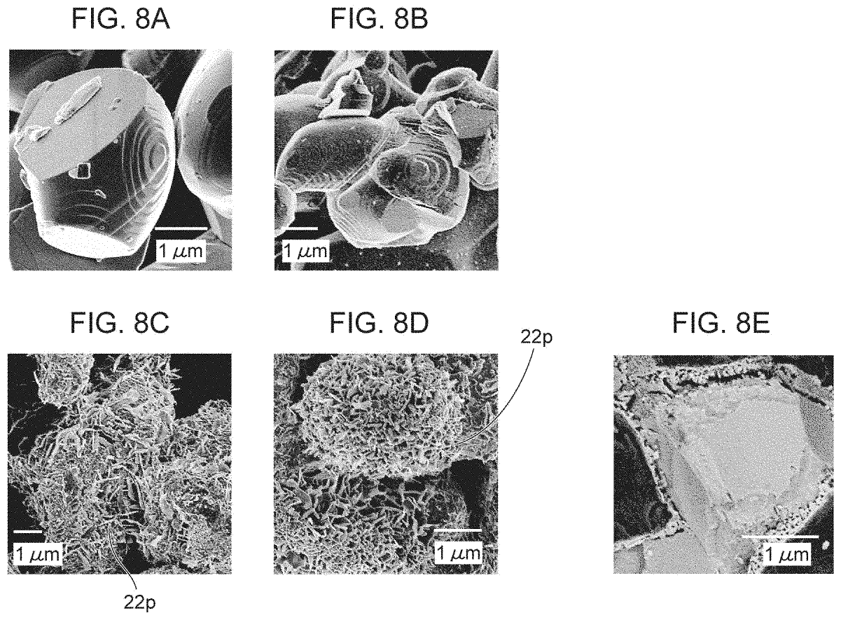

As shown in FIGS. 1A, 2B, and 2C, it is thought that the active material particle 22 with the radial protrusions 22p and made porous has a large effective reaction area for transferring a Li ion to and from an element around the active material particle 22 and efficiently transfers a Li ion. On the other hand, it is assumed that the stable active material particle 21 has a smooth surface as shown in FIG. 8A, has a smaller effective reaction area for transferring a Li ion to and from a neighboring element than the active material particle 22, and cannot efficiently transfer a Li ion. It is thought that the active material particle 22 according to the present embodiment has such characteristic morphological features and thereby has high transport ability (mobility) of the active material particle.

Furthermore, as shown in the X-ray diffraction profile of FIG. 1B, the active material particle 22 has a broad diffraction angle peak shifted to a higher angle side, a smaller crystallite size, and more dispersed orientations than the stable active material particle 21. It is thought that a Li ion is transported along a crystallite inside an active material particle. It is known that the diffusion length of a Li ion inside an active material particle increases as the crystallite size decreases. Thus, it is thought that the active material particle 22 according to the present embodiment has a higher effect of efficiently transporting a Li ion, which is transferred to and from a neighboring element, to the central portion inside the active material particle than the stable active material particle 21. In other words, the active material particle 22 according to the present embodiment is a anode active material having ensured ionic conductivity in the form of a raw material before constituting the anode 30 and a anode active material layer 20.

Thus, it is thought that a secondary battery 100 (FIG. 3A) with improved charge-discharge characteristics is provided by applying the active material particle 22 according to the present embodiment to the anode 30 illustrated in FIG. 3B.

<Structures of Secondary Battery and Anode>

The anode 30 and the secondary battery 100 each containing the active material particle 22 according to the first embodiment are described below with reference to FIGS. 3A and 3B.

FIG. 3A is a schematic cross-sectional view of the secondary battery 100 including the anode 30 to which the active material particle 22 according to the present embodiment is applied. The secondary battery 100 includes an electrolyte layer 40 on a surface of the anode active material layer 20 opposite a anode current collector layer 10 in contact with the anode active material layer 20. The secondary battery 100 includes a cathode 70 on a surface of the electrolyte layer 40 opposite the anode active material layer 20. The cathode 70 includes a cathode active material layer 50 on a surface of the electrolyte layer 40 opposite the anode active material layer 20. The cathode 70 includes a cathode current collector layer 60 on a surface of the cathode active material layer 50 opposite the electrolyte layer 40. In other words, the secondary battery 100 includes the cathode 70, the electrolyte layer 40, and the anode 30 in a lamination direction 200.

As illustrated in FIG. 3B, the anode 30 to which the active material particle 22 according to the present embodiment is applied has the anode current collector layer 10 and the anode active material layer 20, which contains the active material particle 22 and a anode internal electrolyte 24. In the present specification, a structure in which an active material ion is transferred to and from the electrolyte layer 40 is referred to as a anode, and the anode active material layer 20 excluding the anode current collector layer 10 in the anode 30 of FIG. 1A may therefore be referred to as a anode 20. The anode active material layer 20 according to the present embodiment, which contains the anode internal electrolyte 24, may also be referred to as a composite anode active material layer 20.

The current collector layer 10 is a conductor for electronic conduction between an external circuit (not shown) and the active material layer. The current collector layer 10 may be a laminate of a free-standing film of a metal, such as SUS or aluminum, a metal foil, and a resin base.

The anode active material layer 20 includes anode active material layers 20a, 20b, and 20c as sub-layers. The anode active material layers 20a, 20b, and 20c are distinguished by the unit of lamination in the layer thickness direction 200 before the active material particle 22 and the anode internal electrolyte 24 are sintered. The anode active material layers 20a, 20b, and 20c may have a distribution in the layer thickness direction in the volume fractions of the active material particle 22 and the anode internal electrolyte 24, in a conductive aid (not shown), in the voidage (porosity), or the like. The layer thickness direction 200 is parallel or antiparallel to the lamination direction of the layers and may therefore be also referred to as a lamination direction 200.

Cathode

The cathode may be produced by a known method. As in a modified example of a fourth embodiment of the present application, a method for producing the anode 30 according to the first embodiment may be applied to produce the cathode. Like the anode 30, the cathode may be formed of a particle containing a cathode active material or may be produced by forming a film of a metal, such as metallic Li or In—Li.

[Electrolyte]

An electrolyte that can be applied to the electrolyte layer 40 may be a solid electrolyte or a liquid electrolyte. For a solid-state battery containing a solid electrolyte, the electrolyte may be produced in the same manner as in the anode or may be produced by a known method. The known method may be, but is not limited to, a coating process, a powder pressing process, a vacuum process, or the like, as in the cathode. The electrolyte may be produced independently or may be produced collectively as a laminate of the electrolyte and a anode or a cathode or a laminate of the electrolyte, a anode, and a cathode. A liquid electrolyte or a polymer electrolyte produced by a production method different from the production methods of the electrodes may be produced by any method.

[Solid Electrolyte]

A solid electrolyte applicable to the electrolyte layer 40 is, for example, an oxide solid electrolyte, a sulfide solid electrolyte, a complex hydride solid electrolyte, or the like. The oxide solid electrolyte may be a NASICON-type compound, such as Li_{1.5}Al_{0.5}Ge_{1.5}(PO₄)₃ or Li_{1.3}Al_{0.3}Ti_{1.7}(PO₄)₃, or a garnet-type compound, such as Li_{6.25}La₃Zr₂Al_{0.25}O₁₂. The oxide solid electrolyte may be a perovskite compound, such as Li_{0.33}Li_{0.55}TiO₃. The oxide solid electrolyte may be a LISICON-type compound, such as Li₁₄Zn(GeO₄)₄, or an acid compound, such as Li₃PO₄, Li₄SiO₄, or Li₃BO₃. Specific examples of the sulfide solid electrolyte include Li₂S—SiS₂, LiI—Li₂S—SiS₂, LiI—Li₂S—P₂O₅, LiI—Li₃PO₄—P₂S₅, and Li₂S—P₂S₅. The solid electrolyte may be crystalline or amorphous and may be a glass ceramic. The term “Li₂S—P₂S₅” or the like refers to a sulfide solid electrolyte produced by using a raw material containing Li₂S and P₂S₅.

[Liquid Electrolyte]

A liquid electrolyte applicable to the electrolyte layer 40 is, for example, a nonaqueous electrolyte solution. The nonaqueous electrolyte solution is a liquid containing approximately one mole of lithium salt dissolved in a nonaqueous solvent. The nonaqueous solvent may be ethylene carbonate, propylene carbonate, dimethyl carbonate, diethyl carbonate, or ethyl methyl carbonate. The lithium salt may be LiPF₆, LiBF₄, or LiClO₄. An aqueous electrolyte solution containing a water medium may also be used.

[Cathode Active Material]

The cathode active material is, for example, a metal, metal fiber, a carbon material, an oxide, a nitride, silicon, a silicon compound, tin, a tin compound, an alloy material, or the like. Among these, a metal, an oxide, a carbon material, silicon, a silicon compound, tin, a tin compound, or the like is preferred in terms of the capacity density. The metal is, for example, metallic Li or In—Li. The oxide is, for example, Li₄Ti₅O₁₂ (LTO: lithium titanate) or the like. The carbon material is, for example, natural graphite (graphite), coke, graphitizing carbon, carbon fiber, spherical carbon, artificial graphite, amorphous carbon, or the like. The silicon compound is, for example, a silicon-containing alloy, a silicon-containing inorganic compound, a silicon-containing organic compound, a solid solution, or the like. The tin compound is, for example, SnO_{b} (0<b<2), SnO₂, SnSiO₃, Ni₂Sn₄, Mg₂Sn, or the like. The cathode material may contain a conductive aid. The conductive aid is, for example, graphite, such as natural graphite or artificial graphite, or carbon black, such as acetylene black, Ketjen black, channel black, furnace black, lampblack, or thermal black. The conductive aid may be electrically conductive fiber, such as carbon fiber, carbon nanotube, or metal fiber, a fluorocarbon, a metal powder, such as aluminum, electrically conductive whisker, such as zinc oxide, an electrically conductive metal oxide, such as titanium oxide, an organic electrically conductive material, such as a phenylene dielectric, or the like.

### <Method for Producing Secondary Battery>

A secondary battery can be produced by a known method for producing a laminated cell type, a coin cell type, a pressurized cell type, or the like. A typical laminated cell type is described below as an example.

Assembly of Laminated Cell

The assembly of a laminated cell is described below with respect to an all-solid-state battery or a polymer battery. A anode, an electrolyte, and a cathode produced by the production methods described above are stacked between a anode current collector and a cathode current collector. Each current collector is welded to an extraction electrode tab at an end portion thereof. The laminate of the current collectors, the anode, the electrolyte, and the cathode is placed on an Al laminated film, is wrapped with the Al laminated film, and is sealed under vacuum using a vacuum packaging machine. Although the electrode tabs are extracted from the laminated film, the tabs and the Al laminated film are bonded by thermocompression bonding, so that the sealing is maintained. If necessary, the sealing may be followed by pressurization with an isostatic pressing apparatus or the like. The electrolyte may be a solid electrolyte or a polymer electrolyte and may be a laminate of the solid electrolyte and the polymer electrolyte. In addition to the laminate described above, the Al laminated film may include an elastic material layer or a resin material layer for the purpose of strengthening, forming, or the like. Furthermore, a bipolar type (in series/in parallel) in which a plurality of the laminates are stacked may also be used. In a known lithium-ion battery containing a liquid electrolyte, a polyethylene separator is used instead of the electrolyte. A liquid electrolyte is injected and sealed before sealing with a vacuum packaging machine.

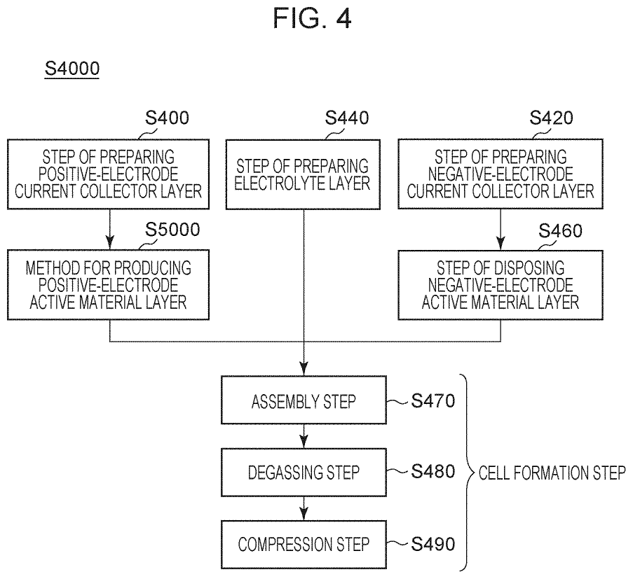

Next, a typical method S4000 for producing a secondary battery to which the active material particle 22 according to the present embodiment can be applied is described below with reference to FIG. 4. FIG. 4 is a flow chart of an example of a method for producing the secondary battery 100 as an all-solid-state battery including a solid electrolyte layer 40.

To produce the all-solid-state battery (the secondary battery 100), first, the raw materials constituting the anode 30, the cathode 70, and the electrolyte layer 40 are prepared. A method for producing the secondary battery 100 according to the present embodiment includes the step of producing the anode 30, which includes a step S400 of preparing the anode current collector layer 10 and a method S5000 for producing the anode active material layer 20. The method S5000 for producing the anode active material layer 20 is described later. Likewise, the method for producing the secondary battery 100 according to the present embodiment includes the step of producing the cathode 70, which includes a step S420 of preparing the cathode current collector layer 60 and a step S460 of disposing the cathode active material layer 50, and a step S440 of preparing the electrolyte layer 40. In the secondary battery production method S4000 according to the present embodiment illustrated in FIG. 4, although the production steps of producing the anode 30, the electrolyte layer 40, and the cathode 70 are performed in parallel, the production steps may be performed in series, or the order of the steps of the anode current collector layer 10 and the anode active material layer 20 may be changed.

Next, the anode 30, the electrolyte layer 40, and the cathode 70 are assembled in an assembly step S470 such that the anode current collector layer 10, the anode active material layer, the solid electrolyte layer 40, the cathode active material layer 50, and the cathode current collector layer 60 are stacked in this order. In the assembly step S470, a sealing member (not shown), such as a sealing film, a heat-sealing material, or a pressure-sensitive sealing material, may be assembled with the anode 30, the electrolyte layer 40, and the cathode 70.

Next, a degassing step S480 of degassing the assembled laminate, which becomes a precursor of the secondary battery, and a compression step S490 of compressing the laminate in the lamination direction are performed. The degassing step S480 and the compression step S490 may be performed simultaneously, or the order of the start time and the finish time in these steps may be changed. The degassing step S480 and the compression step S490 may include the step of sealing the sealing member. When the compression step S490 is performed in a reduced-pressure atmosphere, in a dry atmosphere, or in an inert gas atmosphere, the degassing step S480 may be omitted. The degassing step S480 may also be referred to as a drying step S480 or an evacuation step S480. The assembly step S470, the degassing step S480, and the compression step S490 may also be referred to as a cell formation step.

A constituent (or a precursor thereof) of the secondary battery 100 is in contact with another constituent (or a precursor thereof) adjacent in the layer thickness direction 200 in the cell formation step. As shown in FIG. 2B, the anode active material layer 20 may have a form in which the active material particle 22 and the anode internal electrolyte 24 are in contact with each other in the layer.

The active material particle 22 according to the present embodiment is a particulate active material with secured ionic conductivity and therefore has a high degree of flexibility in the arrangement for obtaining a contact opportunity with the anode internal electrolyte 24, the conductive aid, or the like. Furthermore, the active material particle 22 according to the present embodiment has already had secured ionic conductivity, and it is therefore not necessary to heat a anode precursor pattern to 500° C. to 1000° C. as in the related art in any of the production steps of the secondary battery production method S4000.

Thus, the anode active material layer 20 and the anode 30 in which the active material particle 22 is arranged do not require subsequent heat treatment for improving the transport ability for an active material ion, and the process temperature of the secondary battery production method S4000 can be lowered.

In the degassing step S480 and the compression step S490, the laminate of the secondary battery 100 is placed under high temperature and high pressure. Although the degassing step S480 and the compression step S490 are accompanied by an increase in the temperature of the laminate, heating the laminate from the outside may promote the action of degassing or compression.

Thus, the use of the active material particle 22 according to the present embodiment enables the use of aluminum (melting point 660° C.), which has been desired to be used from the perspective of electrical conductivity and processability in the past but has sometimes not been used as a material for the current collector layer 10 due to the restriction of heat resistance in the cell formation step.

Likewise, the use of the active material particle 22 enables the use of a carbon black powder (spontaneous ignition temperature 500° C.), which has been desired to be used for reasons of material cost, sulfur resistance, or the like but has sometimes not been used as a conductive aid from the perspective of heat resistance in the cell formation step.

Likewise, the use of the active material particle 22 according to the present embodiment enables the use of a NASICON solid electrolyte, which has been desired to be used for reasons of ion transport ability or the like but has sometimes not been used as a anode internal electrolyte from the perspective of heat resistance in the cell formation step. Such a NASICON solid electrolyte contains LAGP/LATP/LICGC or the like, may form a reaction layer with the active material particle 22 at approximately 600° C., and may be eluted. The formation of a reaction layer of a NASICON solid electrolyte and the active material particle 22 may damage the interface structure between the anode 30 and the solid electrolyte layer 40 and reduce the ionic conductivity. The structural formulae LAGP/LATP/LICGC represent Li₁₊ₓAlₓGe₂₋ₓ(PO₄)₃, Li₁₊ₓAlₓTi₂₋ₓ(PO₄)₃, and Li_{1+x+y}AlₓTi₂₋ₓSi_{y}P_{3-y}O₁₂, respectively.

Likewise, in a production process of a secondary battery containing a sulfide solid electrolyte with generally lower heat resistance than an oxide solid electrolyte LBO, LATP, or the like, the use of the active material particle 22 according to the present embodiment can reduce the temperature in the cell formation step. The sulfide solid electrolyte may be Li₂S—SiS₂, LiI—Li₂S—SiS₂, LiI—Li₂S—P₂S₅, LiI—Li₂S—P₂O₅, LiI—Li₃PO₄—P₂S₅, or Li₂S—P₂S₅.

Likewise, in a production process of a secondary battery containing a liquid electrolyte (electrolyte solution) with generally lower heat resistance than a solid electrolyte LBO, LATP, or the like, the use of the active material particle 22 according to the present embodiment can reduce the temperature in the cell formation step. Such a liquid electrolyte may be a nonaqueous electrolyte solution. The nonaqueous electrolyte solution is a liquid containing approximately one mole of lithium salt dissolved in a nonaqueous solvent. The nonaqueous solvent may be ethylene carbonate, propylene carbonate, dimethyl carbonate, diethyl carbonate, or ethyl methyl carbonate. The lithium salt may be LiPF₆, LiBF₄, or LiClO₄. Such a liquid electrolyte may also be an aqueous electrolyte solution containing a water medium.

<Modification Mechanism of Active Material Particle in Production Step>

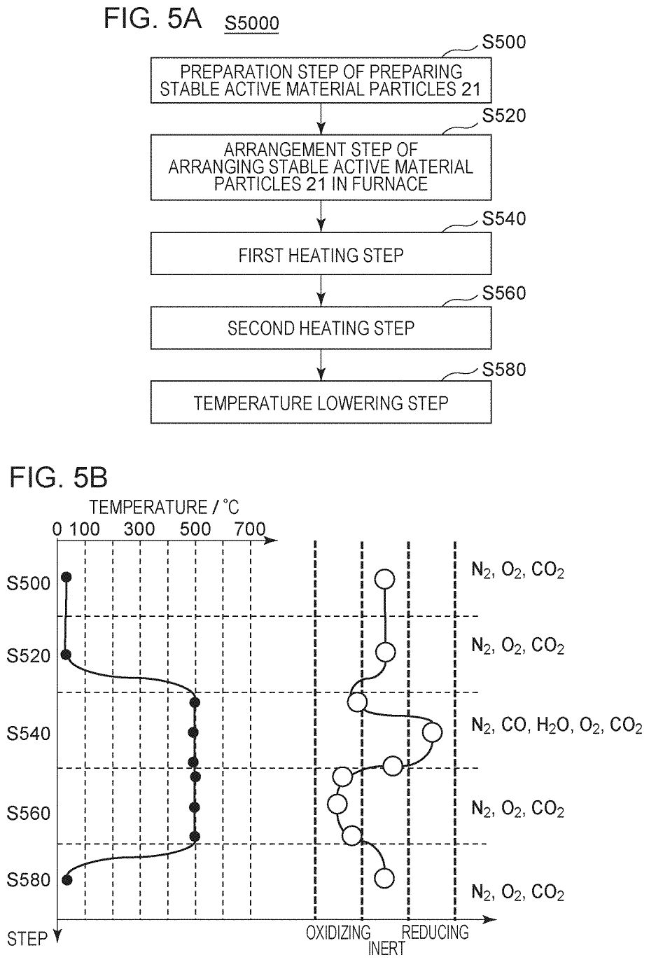

Next, a method for producing the active material particle 22 according to the present embodiment and a modification mechanism of the active material particle 22 are described below with reference to FIGS. 5A to 9D.

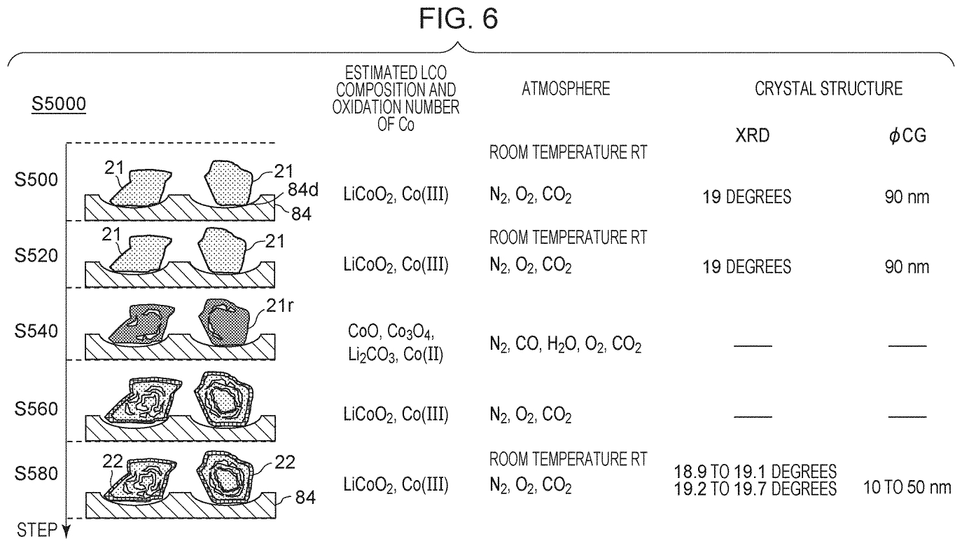

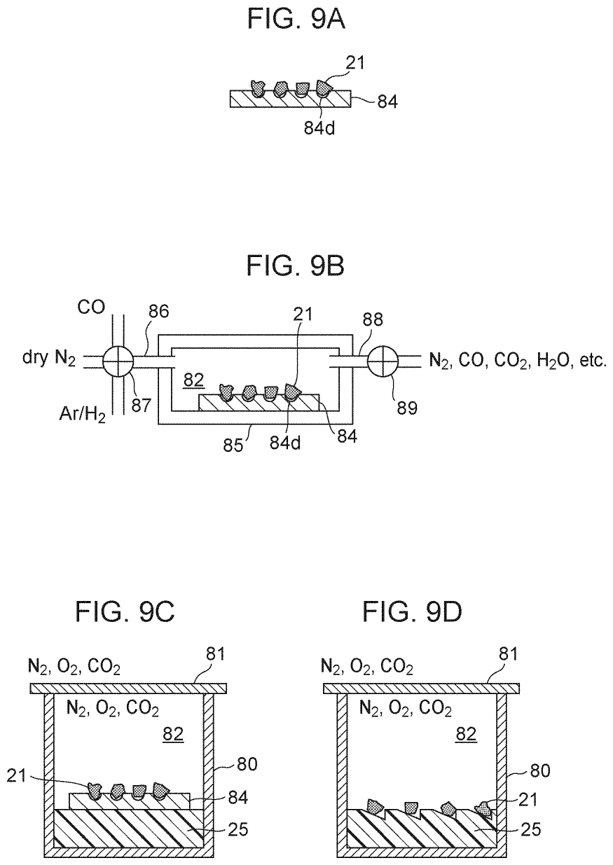

FIG. 5A is a flow chart of a method S5000 for producing the active material particle 22 according to the first embodiment. FIG. 5B illustrates an example of the temperature profile of each step. FIG. 6 illustrates an estimated modification mechanism of the active material particle 22 according to the first embodiment. FIG. 9A is a schematic view of a setting in a furnace in a heating preparation step S520 of the production method S5000.

The method S5000 for producing the active material particle 22 according to the present embodiment is described below with reference to FIGS. 5A, 5B, 6, and 9A. The method S5000 for producing the active material particle 22 includes a step S500 of preparing the stable active material particle 21, the heating preparation step S520 of arranging a resin and the active material particle 21 in the inside of a heating furnace, a first heating step S540, a second heating step S560, and a temperature lowering step S580.

Step S500 of Preparing Stable Active Material Particle 21

As illustrated in FIGS. 1C and 1D, this step is the step of preparing the active material particle 21 containing the stable lithium cobalt oxide. The active material particle 21 containing the stable lithium cobalt oxide is available as a commercial product. From the perspective of the yield and reaction rate of the method for producing the active material particle 22 according to the present embodiment, an active material as a starting material serving as a raw material of the active material particle 22 is also preferably particulate. The particle size of the active material as a starting material is adjusted by classification.

The prepared stable active material particles 21 may be sintered in the first heating step S540 and the second heating step S560 of S5000. Thus, to produce a free-standing active material particle 22 with secured flexibility in arrangement, in the present step S500, the active material particles 21 are arranged on a ceramic plate or the like so as to be separated from each other. In the present step S500, although the active material particles 21 may be prepared as an aggregation of powder without being separated from each other, this requires a subsequent step of separating the prepared active material particles 22 from a sintered body, that is, dividing the sintered body. In such a subsequent step, a fine structure, such as the layered voids 22g or the radial projections 22p, in a particle may fall off or may be lost, and the active material particles 21 are therefore preferably separated in the present step S500.

In this connection, the arrangement of the active material particles 21 so as to be separated from each other in the present step S500 is expected to have an effect of promoting a gas phase reaction described later and an effect of uniformly advancing the gas phase reaction in the first heating step S540 and the second heating step S560.

In the present step S500, as illustrated in FIGS. 6 and 9A, the stable active material particles 21 are disposed on an alumina plate 84 with separated recessed portions 84d in the form of islands. In the first heating step S540 and the second heating step S540 after the present step S520, to prevent the active material particles 21 from sintering and to promote a gas phase reaction in the two heating steps, the active material particles 21 are disposed apart from each other. A material constituting the plate 84 can be replaced with another ceramic, heat-resistant glass, or metal.

The active material particle 21 can be a particle material of a lithium cobalt oxide, which is a stable commercial product. The active material particle 21 corresponds to a precursor or a starting material of the active material particle 22 according to the present embodiment.

In the present step S520, as illustrated in FIGS. 9C and 9D, the active material particle 21 can have a form in which the plate 84 is disposed on a resin 25 from which a reducing gas is released by heating or a form in which the active material particle 21 is disposed directly on the resin 25. The embodiment illustrated in FIG. 9A is an arrangement in which a reducing gas can be supplied from the outside of the heating furnace, whereas the embodiments illustrated in FIGS. 9C and 9D are modified examples of the first embodiment different in that a reducing gas is supplied from the inside of a furnace by thermal decomposition of the resin 25 to be fired together. As illustrated in FIGS. 9B and 9C, the resin 25 may be in the form of a bulk, a powder, or a chip. The resin 25 and the active material particle 21 correspond to a precursor of the active material particle 22 in the present step S500 to the second heating step S560.

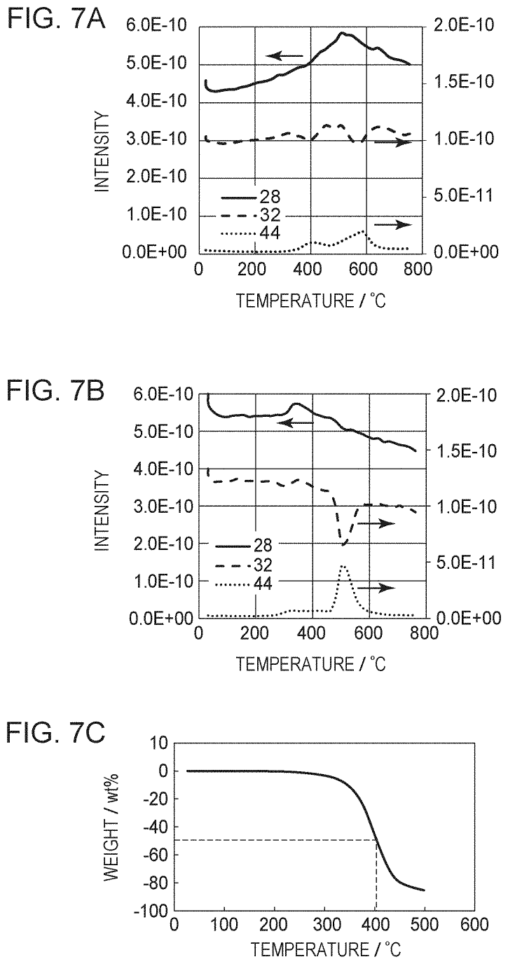

In the modified embodiments illustrated in FIGS. 9B and 9C, the resin 25 is selected from materials that can be thermally decomposed to a solid content of 0 in the first heating step S540. In other words, a material with a transformation temperature, such as a thermal decomposition temperature or a combustion temperature, depending on the atmosphere and heating profile of the first heating step S540 is selected. When the resin 25 is a poly(ethylene terephthalate) (PET) resin, as illustrated in FIGS. 7A and 7B described later, the resin 25 is thermally decomposed while releasing a gas with a specific equivalent atomic weight in each temperature range. When the resin 25 is a PET resin illustrated in FIGS. 7A and 7B, the resin 25 can be burned to a solid content of 0 in an oxygen-containing atmosphere at a heating temperature of 450° C. or more.

In other words, the resin 25 is a supply source for supplying a reducing gas for reducing cobalt contained in the stable active material particle 21 in the first heating step S540 and is a material for adjusting the atmosphere that provides the conditions for moving from the first heating step S540 to the second heating step S560.

The present step S500 is performed at room temperature RT (15° C. to 25° C.) in an air atmosphere. When a patterning apparatus or a clean bench is used, the present step may be performed in a specific temperature range in an inert atmosphere purged with an inert gas. To reduce the influence of adsorbed water, an atmosphere of 50° C. or more may be used, or the plate 84 may be heated.

Arrangement Step S520 of Arranging Stable Active Material Particles in Inside of Heating Furnace

As illustrated in FIG. 9B, the present step S520 is the step of disposing the active material particle 21, which is a precursor of the active material particle 22, in the inside 82 of the heating furnace.

The heating furnace may be of a batch type, a continuous type, a single wafer type, or the like, and may be of a type in which a casing is provided to partly cover a heating region in which the active material particle 21 is disposed in order to provide a predetermined atmosphere in a space for heating the active material particle 21. The inside of the heating furnace can be set to a predetermined atmosphere and a predetermined temperature. The heating furnace may have a form in which the gas conductance between the inside and the outside of the heating furnace or between the inside and the outside of an inner container, such as a crucible, is limited at least in order to set the atmosphere of the space for heating the active material particle 21 to a predetermined atmosphere. This makes it possible to efficiently bring the active material particle 21 into contact with a reactive gas in the first heating step S540 and the second heating step S560 described later. For a main component of the atmosphere or a reactive gas lighter than the equivalent atomic weight of 29 of the air, a casing that mainly covers an upper portion of the heating furnace is effective.

In an embodiment in which the heating furnace is not completely sealed, the pressure (the total pressure) of the inside of the furnace in the first heating step S540 and the second heating step S560 is considered to be in an isobaric relationship with the surroundings. For safety reasons, the heating furnace may be placed in a room, a workbench, or the like that is evacuated to a slightly negative pressure (0.8 to 0.95 atm). When the heating furnace is in the air, it is thought that the inside of the furnace is maintained at the atmospheric pressure to a slightly negative pressure of the atmospheric pressure in a heating step, and the atmosphere is constituted by nitrogen N₂, which is stable and inert up to a predetermined temperature range.

The present step can be performed at room temperature RT (15° C. to 25° C.) in an air atmosphere as in the preparation step S500. When a patterning apparatus or a clean bench is used, the present step may be performed in a specific temperature range in an inert atmosphere purged with an inert gas. To reduce the influence of adsorbed water, an atmosphere of 50° C. or more may be used, or the stage on which the resin 25 is disposed may be heated.

In the first embodiment, both the preparation step S500 and the arrangement step S520 are performed at a room temperature of 20° C. in an air atmosphere. Thus, in the preparation step S500 and the arrangement step S520, the resin 25 and the active material particle 21 are in an air atmosphere containing nitrogen, oxygen, and carbon dioxide.

First Heating Step S540

The present step S540 is the step of bringing the active material particle 21 containing the stable lithium cobalt oxide into contact with a reducing gas while heating the active material particle 21 to thermally reduce cobalt contained in the active material particle 21. In other words, the present step S540 is the step of bringing the active material particle 21 containing the stable lithium cobalt oxide into contact with a reducing gas while heating the active material particle 21 to produce an active material particle 21r containing reduced cobalt.

In the present step S540, a reducing gas supplied from an inlet port 86 is brought into contact with the active material particle 21 in the inside 82 of the heating furnace. The reducing gas supplied from the inlet port 86 contains H₂ (Ar/H₂) diluted with an inert gas, carbon monoxide CO, carbon monoxide CO diluted with nitrogen N₂, and the like. The feed rate of the reducing gas supplied from the inlet port 86 is controlled with a regulator, a pressure gauge, a flowmeter, or the like (not shown). Furthermore, an inlet valve 87 and an exhaust valve 89 may be independently controlled to adjust partial pressures of the gas components carbon dioxide CO₂ and water H₂O consumed and produced in the reduction reaction and a gas component oxygen O₂ contained in the inside 82 of the furnace from the arrangement step S520. Adjusting the exhaust valve allows at least part of a gas produced by combustion, a thermally decomposed gas, and the like to be exhausted from an exhaust port 88 coupled to an exhaust system (not shown). An atmosphere containing a reducing gas as a main component among active gas components as in the first heating step S540 may be referred to as a reducing atmosphere.

The modified embodiments illustrated in FIGS. 9C and 9D include the step of bringing a reducing gas released by thermally decomposing the resin 25 into contact with the active material particle 21. In other words, the heating step S540 in the modified embodiments illustrated in FIGS. 9C and 9D is performed until the atmosphere of the inside 82 of the heating furnace becomes an oxidizing atmosphere in which a reducing gas derived from a resin contained in the resin 25 is decreased and the partial pressure of an oxidizing gas containing oxygen exceeds the partial pressure of the reducing gas. The first heating step S540 in the present embodiment is started in an oxygen-containing atmosphere containing oxygen O₂. The heating temperature in the first heating step S540 in the present embodiment can be 300° C. or more and 690° C. or less.

The present inventors assume that, in the first heating step S540, the active material particle 21 is subjected to a thermal reduction reaction with carbon monoxide CO derived from the resin 25, which reduces cobalt Co and makes the microstructure in the particle porous.

In a heating furnace 85, a heater (not shown) can heat the atmosphere of the inside 82 of the furnace, the active material particle 21, and the plate 84. The heating temperature is monitored with a thermocouple, an infrared sensor, or the like.

In the present embodiment, in FIG. 9B, carbon monoxide CO diluted with nitrogen N₂ (N₂/CO) is supplied as a reducing gas to the inside 82 of the furnace.

Second Heating Step S560

In the second heating step S560, in the active material particle 21r in which at least part of cobalt is reduced, reduced cobalt is oxidized by oxygen O₂ remaining in the atmosphere instead of the reducing gas (carbon monoxide CO) the supply of which has been stopped, and returns to a lithium cobalt oxide. The present inventors estimate that the LCO produced by the reoxidation has a fine structure and a crystal structure different from those of the stable LCO. The heating temperature in the second heating step S560 can be 400° C. or more and 690° C. or less.

The reasons for these are described below with reference to FIGS. 5A, 5B, 6, 7A to 7C, and 8A to 8D.

FIGS. 7A and 7B show the results of differential thermal analysis. FIG. 7A is a differential thermal analysis DTA profile of a sheet-like PET resin used for the resin 25. In the figure, the solid line is a DTA curve for an equivalent atomic weight of 28 (left axis), the broken line is a DTA curve for an equivalent atomic weight of 32 (right axis), and the dotted line is a DTA curve for an equivalent atomic weight of 44 (right axis). The equivalent atomic weight of 28 may be nitrogen N₂ or carbon monoxide. However, nitrogen gas is unlikely in consideration of the DTA curve profile that increases at room temperature to 520° C. and decreases at 520° C. or more, the composition of the PET resin, and the analysis environment. Thus, the solid line profile is considered to be carbon monoxide CO. The broken and dotted line profiles are considered to be oxygen O₂ and carbon dioxide CO₂, respectively, for the same reasons.

FIG. 7A shows that the PET resin is gradually thermally decomposed by heating from room temperature and releases carbon monoxide CO with a peak around 520° C. Furthermore, oxygen and carbon dioxide showing qualitatively opposite trends in increase and decrease show that part of carbon monoxide CO or part of carbon constituting the PET resin consumes oxygen in the atmosphere and is converted into carbon dioxide CO₂. Carbon dioxide CO₂ begins to increase mainly at higher temperatures than carbon monoxide CO and reaches a peak at approximately 590° C.

On the other hand, the thermal decomposition temperature of the PET resin used for the resin 25 was approximately 400° C. as defined by the solid content 50% reduction temperature in the thermogravimetric analysis TG profile shown in FIG. 7C.

Thus, it can be considered that the first heating step S540 includes the step of bringing a reducing gas supplied from the outside or the inside 82 of the furnace into contact with the stable active material particle 21.

Next, FIG. 7B is a differential thermal analysis DTA profile in which the sheet-like PET resin corresponding to FIG. 7A and a plurality of stable active material particles 21 are fired together.

In FIG. 7B, carbon monoxide CO, which increases with the temperature in the temperature range of 520° C. or less in the case of the PET resin alone, starts to decrease at 350° C. or more. It is therefore assumed that part of carbon monoxide derived from the PET resin is consumed in a thermal reduction reaction of LCO at 350° C. or more. More specifically, it is assumed from FIG. 7B that the stable lithium cobalt oxide is thermally decomposed by carbon monoxide CO at 350° C. or more. When the PET resin is fired together with the active material particle 21 containing LCO, it is assumed that at least part of carbon monoxide CO released is immediately consumed in the thermal reduction reaction of LCO at 350° C. or more and is directly oxidized to carbon dioxide CO₂ by the surrounding oxygen at 510° C. or more. Thus, in the first heating step S540, it is assumed that at least part of carbon monoxide CO derived from the resin 25 is immediately consumed in the thermal reduction reaction of LCO at 350° C. or more and is consumed to produce carbon dioxide CO₂ at 510° C. or more.

The present inventors used a small container including a crucible 80 and a lid 81 as illustrated in FIG. 9C to examine the heating atmosphere dependency of the active material particle 21 and the resin 25 containing PET in an air atmosphere.

FIG. 8A is a SEM image of the appearance of active material particles subjected to a first heating test step of heating only the active material particles 21 without the resin 25 at a temperature of 400° C. for one hour in an air atmosphere in the crucible 80 covered with the lid 81 and subjected to a second heating test step of heating the active material particles 21 at 510° C. for one hour. The active material particles in FIG. 8A were subjected to the heating tests without a supply source for generating reducing gas CO. Thus, although the active material particles are seemed to be affected by an active gas including oxygen O₂, the active material particles had the appearance of a stable lithium cobalt oxide without radial protrusions.

FIG. 8B is a SEM image of the appearance of active material particles subjected to a first heating test step of heating the resin 25 and the active material particles 21 at a temperature of 400° C. for one hour in an air atmosphere in the crucible 80 without the lid 81 and subjected to a second heating test step of heating the active material particles 21 at 510° C. for one hour. The active material particles in FIG. 8B were subjected to the heating tests while a reducing gas carbon monoxide CO generated from the resin 25 diffused outside the crucible 80 and did not remain in the crucible 80. It is therefore assumed that the active material particles were affected by active gases of both oxygen O₂ and carbon monoxide CO. The active material particles in FIG. 8B had the appearance of a stable lithium cobalt oxide without radial protrusions. The results of this test showed the appearance of a stable lithium cobalt oxide without radial protrusions in the crucible 80 covered or not covered with the lid 81 only in the second heating test step.

FIG. 8C is a SEM image of the appearance of active material particles subjected to a first heating test step of heating the resin 25 and the active material particles 21 at a temperature of 400° C. for one hour in an air atmosphere in the crucible 80 with the lid 81 and subjected to a second heating test step of heating the active material particles 21 at 510° C. for one hour without the lid 81. The active material particles in FIG. 8C were subjected to the heating tests while a reducing gas carbon monoxide CO generated from the resin 25 remained in the crucible 80, and were therefore assumed to be affected by a reducing active gas containing carbon monoxide CO. The active material particles in FIG. 8C had radial protrusions and had an appearance similar to the appearance of the active material particle 22 according to the present embodiment.

FIG. 8D is a SEM image of the appearance of active material particles subjected to a first heating test step of heating the resin 25 and the active material particles 21 at a temperature of 400° C. for one hour in an air atmosphere in the crucible 80 covered with the lid 81 and then subjected to a second heating test step of heating the active material particles 21 at 510° C. for one hour. The active material particles in FIG. 8D were subjected to the first heating test step while a reducing gas carbon monoxide CO generated from the resin 25 remained in the crucible 80, and were therefore assumed to be fired in a reducing atmosphere containing carbon monoxide CO as an active gas. The active material particles in FIG. 8D were then subjected to the second heating test step after the supply of the reducing gas carbon monoxide CO was stopped as the resin 25 was thermally decomposed, and were therefore assumed to be fired in an oxidizing atmosphere containing oxygen O₂ as an active gas. The active material particles in FIG. 8D had radial protrusions and had an appearance similar to the appearance of the active material particle 22 according to the present embodiment. FIG. 8E is a cross-sectional SEM image of the active material particles of FIG. 8D. The cross section of the active material particles in FIG. 8D shows radial protrusions outside the particle portion and a porous fine structure, such as a layered void, in the particle portion.

An active material particle whose heating atmosphere dependency was examined was subjected to X-ray diffractometry. As a result, cobalt oxide (CoO) and lithium carbonate (Li₂CO₃) in addition to LCO were detected only in an active material particle after the first heating test step corresponding to FIGS. 8C and 8D. In other words, cobalt with an oxidation number III and cobalt with an oxidation number II were detected only in an active material particle after the first heating test step corresponding to FIGS. 8C and 8D.

In a cross-sectional SEM image of a LCO particle after the second heating test step of FIG. 8D, a void, which was not observed in a cross section before heating in FIG. 4A, was observed in the LCO particle. However, the deposition of protrusions was not observed on the surface of the LCO particle.

On the other hand, when a sample subjected to the firing conditions at 510° C. in the second heating test step corresponding to FIG. 8D was reheated at 700° C. for 10 minutes, the inside of an active material particle of the sample had a homogeneous structure and had the morphology of a stable LCO without protrusions on the particle surface (not shown). The porous structure containing the protrusion 22p and the layered void 22g was lost by firing in the heating test at 700° C. Thus, it is thought that an oxidation reaction and a melt reaction proceeded excessively at 700° C. or more, thus resulting in a stable LCO without a fine structure or a characteristic crystal structure.

Thus, in the second heating step of reoxidizing the active material particle 21r containing cobalt reduced in the first heating step, the heating temperature can be set to 690° C. or less to prevent oxidation and melting from proceeding to a stable LCO.

On the basis of the analysis results of FIGS. 7A to 7C and 8A to 8E, FIGS. 5A and 5B and FIG. 6 illustrate a figure of each step drawn by the present inventors. FIGS. 5A and 5B and FIG. 6 illustrate estimated mechanisms corresponding to the steps S500 to S580.

In the preparation step S500 and the arrangement step S520, there is no significant structural change in the active material particle 21 (a precursor of the active material particle 22).

In the first heating step S540, the active material particle 21 is heated to 500° C. At the beginning of the first heating step S540, cobalt in the active material particle 21 in contact with the supplied reducing gas carbon monoxide CO is reduced from a valence of II to a valence of III, and at least part of the lithium cobalt oxide is modified to cobalt oxide (CoO/Co₃O₄). Furthermore, at the beginning of the first heating step S540, cobalt in the active material particle 21 in contact with the supplied reducing gas carbon monoxide CO is reduced from a valence of II to a valence of III, and the active material particle 21 is modified into a reduced active material particle 21r with a fine structure in which the inside of the particle is made porous. The supplied carbon monoxide CO dominates as an active gas of the heating atmosphere at the beginning of the first heating step S540 and is consumed for the modification of LCO. After the supply of the carbon monoxide CO is stopped in the late stage of the first heating step S540, the carbon monoxide CO is oxidized into inert carbon dioxide CO₂ by oxygen O₂ in the atmosphere, and the reducing atmosphere of the inside 82 of the furnace is shifted to an inert atmosphere.

Furthermore, in the second heating step S540, when the partial pressure of the carbon monoxide CO becomes substantially zero, the partial pressure of the carbon dioxide CO₂ is lowered, and the oxygen O₂ is not consumed, so that high-temperature active oxygen O₂ reoxidizes the active material particle 21r in which part of the cobalt is reduced. Thus, the atmosphere in the second heating step S560 is dominated by high-temperature oxygen O₂ and is shifted from inert to oxidizing.

In the second heating step S560, the oxidation number of at least part of the cobalt Co in the active material particle changes from II or II2/3 to III. In the second heating step S560, it is thought that the oxidation reaction does not proceed completely in the particle, and the layered void 22g formed in the first heating step and the protrusion 22p formed in the first half of the second heating step remain even after the temperature lowering step S580. The phrase “the oxidation reaction does not proceed completely” may be expressed as “an incomplete oxidation reaction proceeds” or “a local oxidation reaction proceeds”.

In an modified embodiment with the setting of FIG. 9C, a test was performed to examine the temperature rising rate dependency by changing only the level of the temperature rising rate in the first heating step S540. As a result of the test for examining the temperature rising rate dependency, at a temperature rising rate of 10° C./min or less, an active material particle thus produced had the same fine structure and crystal structure as those of the active material particle 22 of the first embodiment. At a temperature rising rate of more than 10° C./min, an active material particle thus produced did not have the same fine structure and crystal structure as those of the active material particle 22 of the first embodiment. It is thought that such temperature rising rate dependency requires that the active material particle 21 remains for 20 minutes or more in the temperature range of 300° C. or more and 500° C. or less in which carbon monoxide CO is generated from the resin 25 in the first heating step. It is assumed that, when the temperature rising rate is more than 10° C./min and the dwell time of the active material particle 21 in the temperature range of 300° C. to 500° C. is less than 20 minutes, the PET resin is rapidly and completely burned, inert carbon dioxide CO₂ is supplied from the beginning of the heating step, and carbon monoxide CO is insufficiently supplied. The second heating step S560 can be performed at 400° C. or more and 690° C. or less for 10 minutes or more and 90 minutes or less. The dwell time of the active material particle 21 in the temperature range of 300° C. or more and 500° C. or less may also be referred to as the heating time of the active material particle 21 in the temperature range of 300° C. or more and 500° C. or less.

Temperature Lowering Step S580

The present step is the step of lowering the temperature of the active material particle 22 containing cobalt reoxidized after reduction to produce a modified active material particle 22. After the second heating step S560, which is a local oxidation reaction, as illustrated in FIG. 6, a fine structure in an active material particle formed in S540 to S560 is retained in the present step S560.

### Second Embodiment

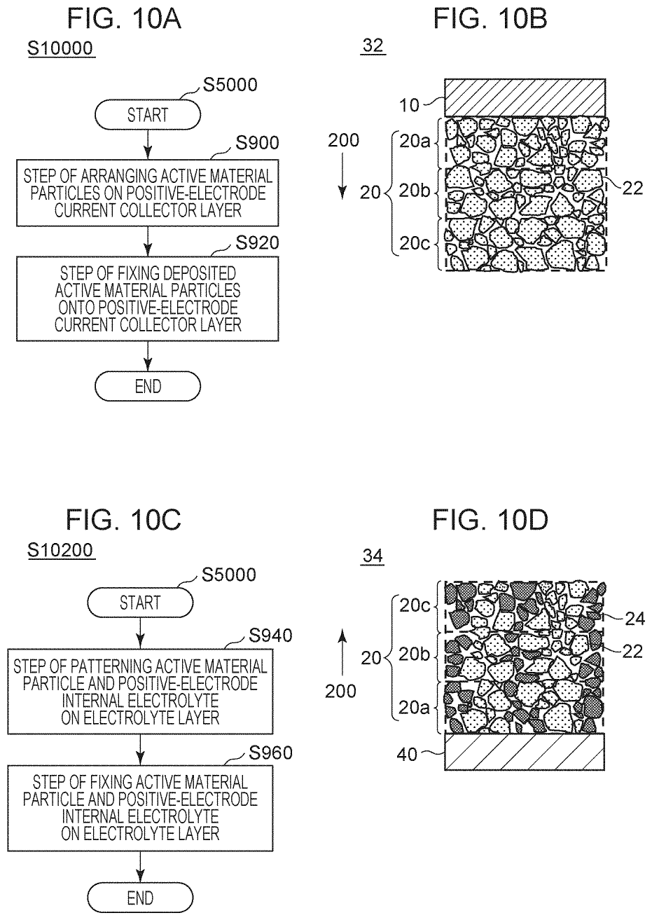

A anode 32 according to the second embodiment is described below with reference to FIGS. 10A and 10B. FIGS. 10A and 10B are a flow chart and a schematic cross-sectional view showing a method S10000 for producing the anode 32 according to the second embodiment. The anode 32 according to the present embodiment is different from the anode 30 according to the first embodiment illustrated in FIG. 3B in that the anode active material 20 is composed of the active material particles 22 without the anode internal electrolyte.

As illustrated in FIG. 10A, the anode 32 according to the present embodiment starts with the preparation of the active material particle 22 by the method S5000 for producing the active material particle 22 according to the first embodiment.

Next, the above step is followed by a step S900 of arranging the active material particles 22 on the anode current collector layer 10 using a known particle deposition technique. The step S900 of arranging the active material particles 22 on the anode current collector layer 10 may sometimes include the step of arranging the active material particles 22 on a predetermined surface. The particle deposition technique may appropriately be an ink jet method, a spin coating method, a screen printing method, a chemical vapor deposition CVD method, vapor deposition, electrophotography, or the like.

Next, the above step is followed by a step S920 of fixing the deposited active material particles 22 onto the anode current collector layer 10. The present step S920 includes the application of energy, such as heating or light irradiation. The present step S920 includes the step of applying energy to thermally decompose a binder matrix component provided on the anode current collector layer 10 in the previous step S900 and vaporize a solvent component. The present step S920 includes the step of applying energy to bind the active material particles 22 having a weak binding force to each other.

The heating temperature in the step S920 is preferably a temperature of less than 700° C., for example, 690° C. or less, at which cobalt contained in the active material particle 22 is completely oxidized to a stable lithium cobalt oxide.

Next, a anode 34 according to a modified embodiment of the second embodiment is described below with reference to FIGS. 10C and 10D. FIGS. 10C and 10D are a flow chart and a schematic cross-sectional view showing a method S10200 for producing the anode 34 according to the present modified embodiment.

As illustrated in FIG. 10D, the anode 34 is different from the anode 30 according to the first embodiment in that the anode active material 20 and the anode internal electrolyte 24 have a sea-island pattern in each of the anode active material layers 20a, 20b, and 20c and that the anode active material layer 20 is deposited on an electrolyte layer 40. The anode 34 is also different from the anode 30 according to the first embodiment in that the sea-island pattern is uniform between the anode active material layers 20a, 20b, and 20c.

Similarly to the first embodiment, as illustrated in FIG. 10C, the anode 34 according to the present embodiment starts with the preparation of the active material particle 22 by the method S5000 for producing the active material particle 22 according to the first embodiment.

Next, the above step is followed by a step S940 of patterning the active material particle 22 and the anode internal electrolyte 24 on the electrolyte layer 40 using a known particle deposition technique.

Next, the above step is followed by a step S960 of fixing the pattern of the active material particle 22 and the anode internal electrolyte 24 on the electrolyte layer 40.

### Third Embodiment

<Structure of Anode and Structure of Active Material Particle>

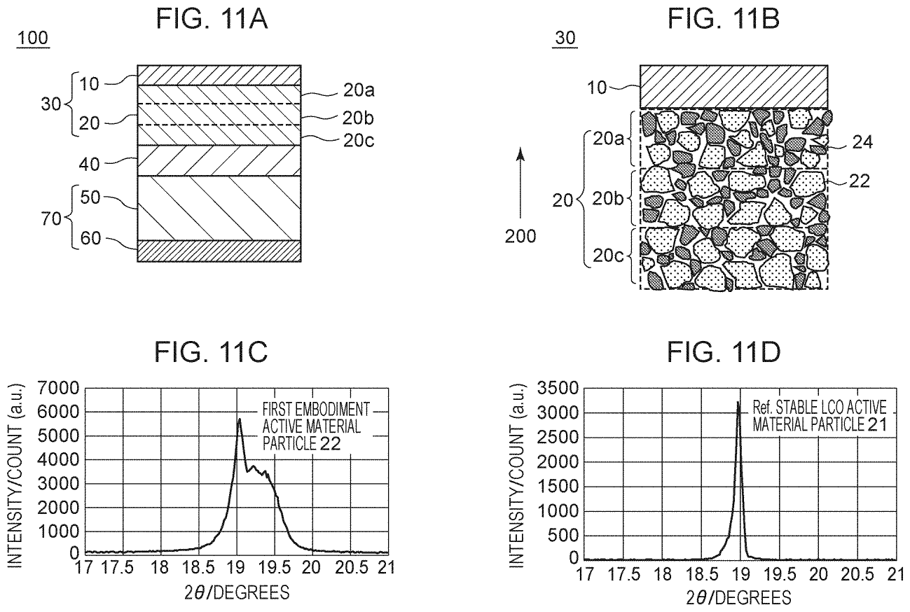

A anode 30 containing an active material particle 22 according to a third embodiment is described below with reference to FIGS. 11A to 11C. FIG. 11A is a schematic cross-sectional view of a secondary battery 100 according to the third embodiment. FIG. 11B is a schematic cross-sectional view of the anode 30. FIG. 11C is an X-ray diffraction profile of the active material particle.

FIG. 11A is a schematic cross-sectional view of the secondary battery 100 to which the anode 30 according to the present embodiment is applied. The secondary battery 100 includes an electrolyte layer 40 on a surface of the anode active material layer 20 opposite a anode current collector layer 10 in contact with the anode active material layer 20. The secondary battery 100 includes a cathode 70 on a surface of the electrolyte layer 40 opposite the anode active material layer 20. The cathode 70 includes a cathode active material layer 50 on a surface of the electrolyte layer 40 opposite the anode active material layer 20. The cathode 70 includes a cathode current collector layer 60 on a surface of the cathode active material layer 50 opposite the electrolyte layer 40. In other words, the secondary battery 100 includes the cathode 70, the electrolyte layer 40, and the anode 30 in a lamination direction 200.

As illustrated in FIG. 11B, the anode 30 according to the present embodiment has the anode current collector layer 10 and the anode active material layer 20, which contains the active material particle 22 and a anode internal electrolyte 24. In the present specification, a structure in which an active material ion is transferred to and from the electrolyte layer 40 is referred to as a anode, and the anode active material layer 20 excluding the anode current collector layer 10 in the anode 30 of FIG. 11A may therefore be referred to as a anode 20. The anode active material layer 20 according to the present embodiment, which contains the anode internal electrolyte 24, may also be referred to as a composite anode active material layer 20.

The current collector layer 10 is a conductor for electronic conduction between an external circuit (not shown) and the active material layer. The current collector layer 10 may be a laminate of a free-standing film of a metal, such as SUS or aluminum, a metal foil, and a resin base.

The anode active material layer 20 includes anode active material layers 20a, 20b, and 20c as sub-layers. The anode active material layers 20a, 20b, and 20c are distinguished by the unit of lamination in the layer thickness direction 200 before the active material particle 22 and the anode internal electrolyte 24 are sintered. The anode active material layers 20a, 20b, and 20c may have a distribution in the layer thickness direction in the volume fractions of the active material particle 22 and the anode internal electrolyte 24, in a conductive aid (not shown), in the voidage (porosity), or the like. The layer thickness direction 200 is parallel or antiparallel to the lamination direction of the layers and may therefore be also referred to as a lamination direction 200.

The active material particle 22 according to the present embodiment contains LiCoO₂ (lithium cobalt oxide: hereinafter sometimes abbreviated to LCO), and the anode internal electrolyte 24 contains Li₃BO₃ (lithium borate: hereinafter sometimes abbreviated to LBO). The particle sizes of the active material particle 22 and the anode internal electrolyte 24 can be adjusted by classification. The active material particle 22 (LCO) and the anode internal electrolyte 24 (LBO) according to the present embodiment have different average particle sizes, and the average particle size of the active material particle 22 is approximately 2 to 3 times the average particle size of the anode internal electrolyte 24. In the present specification, a particle containing an active material Li contained in the anode active material layer 20 is referred to as the active material particle 22. When the cathode active material layer 50 capable of receiving the active material Li contains a cathode active material particle, the active material particle 22 may be referred to as a anode active material particle to be distinguished from the cathode active material particle. The active material particle 22 may be simply referred to as a anode active material without considering granularity.

On the basis of study results by the present inventors, it has been found that the charge-discharge and characteristics of a secondary battery, which have been limited due to a high transfer barrier of an active material ion between an active material particle and an electrolyte, can be improved by using a metastable lithium cobalt oxide as a predetermined active material particle. More specifically, the present inventors have found that, to increase the conductivity of an active material ion, it is preferable to use a metastable lithium cobalt oxide in which the crystal structure of an active material particle is different from that of a stable lithium cobalt oxide.

FIG. 11C is an X-ray diffraction angle profile by the 2θ method of the anode 30 in the secondary battery 100 according to the present embodiment decomposed and measured by X-ray diffractometry (hereinafter sometimes referred to as the XRD method). As shown in FIG. 11C, the X-ray diffraction angle profile has bimodal diffraction angle peaks at 18.9 degrees or more and 19.1 degrees or less and at 19.2 degrees or more and 19.7 degrees or less in the X-ray diffraction angle range of 18 degrees to 20 degrees. On the other hand, it is known that a stable lithium cobalt oxide has a unimodal diffraction angle peak in the range of 18.9 degrees to 19.1 degrees.

More specifically, the diffraction angle peak on the low angle side of the active material particle 22 observed at a diffraction angle of 18.9 degrees or more and 19.1 degrees or less is an overlapping diffraction angle peak of 19.01 degrees and 19.03 degrees. For the sake of simplicity, the diffraction angle peak on the low angle side is represented by the diffraction angle peak with the highest intensity at 19.03 degrees. The diffraction angle peak of the active material particle 22 at 19.03 degrees had a half-width of 0.22 degrees. The diffraction angle peak on the high angle side of the active material particle 22 observed at a diffraction angle of 19.2 degrees or more and 19.7 degrees or less is also an overlapping diffraction angle peak. For the sake of simplicity, the diffraction angle peak on the high angle side is represented by the diffraction angle peak with the highest intensity at 19.25 degrees. More specifically, the diffraction angle peak on the high angle side of the active material particle 22 is an overlapping diffraction angle peak of a plurality of diffraction angle peaks at 19.25 degrees, 19.41 degrees, 19.43 degrees, 19.53 degrees, and 19.61 degrees. The diffraction angle peak of the active material particle 22 at 19.25 degrees had a half-width of 0.54 degrees.

The crystallite sizes φgc of crystal structures corresponding to the diffraction angle peaks of the active material particle 22 at 19.03 degrees and 19.25 degrees were 36.6 nm and 14.9 nm, respectively, from the Scherrer equation of the formula (1).

Scherrer equation: τ=Kλ/(βcos θ) formula (1)

The parameters in the formula (1) are T: crystallite size, K: form factor (0.9), λ: X-ray wavelength, β: half-width of diffraction angle peak, and θ: Bragg angle.

As a reference embodiment, FIG. 11D shows an XRD profile of a lithium cobalt oxide sold as a commercial product including a diffraction angle 2θ of approximately 18 to 20 degrees. The active material particle 21 containing a stable LCO according to the reference embodiment is a virgin commercial product not subjected to the first heating step and the second heating step described later. (Registered trademark CELLSEED manufactured by Nippon Chemical Industrial Co., Ltd.). It can be shown that the active material particle 21 containing the stable LCO has a single peak at 18.9 degrees, which is slightly lower than 19 degrees. The crystallite size φgc of a crystal structure corresponding to the diffraction angle peak of the active material particle 21 at 18.95 degrees was 89.6 nm from the Scherrer equation of the formula (1). The diffraction angle peak at a diffraction angle 2θ of approximately 19 degrees in the X-ray diffraction angle range of 18 degrees to 20 degrees corresponds to a (003) plane of a lithium cobalt oxide crystal.

The active material particle 22 according to the present embodiment has a characteristic broad high-angle diffraction angle peak at 19.2 degrees or more and 19.7 degrees or less, which is not observed in the active material particle 21 containing the stable lithium cobalt oxide. In other words, the active material particle 22 according to the present embodiment has a plurality of diffraction angle peaks at X-ray diffraction angles of 19.2 degrees or more and 19.7 degrees or less by the 2θ method. In other words, the active material particle 22 according to the present embodiment has a high-angle diffraction angle peak at an X-ray diffraction angle of 19.2 degrees or more and 19.7 degrees or less and a low-angle diffraction angle peak at an X-ray diffraction angle of 18.9 degrees or more and 19.1 degrees or less by the 2θ method.

The active material particle 22 in the anode 30 according to the present embodiment has a plurality of characteristic peaks (19.25 degrees, 19.41 degrees, 19.43 degrees, 19.53 degrees, and 19.61 degrees) splitting on a higher angle side than a stable lithium cobalt oxide. The plurality of diffraction angle peaks show that the active material particle 22 according to the present embodiment has a plurality of crystal structures with a distribution in lattice spacing and crystallite size. The plurality of diffraction angle peaks also show that the active material particle 22 according to the present embodiment has a plurality of crystal structures with smaller lattice spacing and crystallite size than the stable active material particle 21. The plurality of diffraction angle peaks also show that the active material particle 22 has a plurality of crystal structures with a smaller lattice spacing and a smaller crystallite size than the stable active material particle 21. In other words, a plurality of crystal structures with a smaller lattice spacing and a smaller crystallite size than the stable active material particle 21 are mixed in the active material particle 22.

Thus, it can be shown that the crystallite size of the active material particle 22 in the anode 30 according to the present embodiment is smaller than the crystallite size of the stable active material particle 21. It is thought that the active material particle 22 has a crystallite size of 10 nm or more and 50 nm or less in consideration of the distribution of diffraction angle peaks at a diffraction angle of 19.2 degrees or more and 19.7 degrees or less.

When the crystal structure of an active material particle in the anode is analyzed by X-ray diffractometry, a sample may be prepared not only from a free-standing form of the anode 30 as in the present embodiment but also from a powder of the active material particle 22 collected by disassembling the secondary battery 100 and grinding the anode 30. Furthermore, a sample containing another constituent contained in the secondary battery can be prepared as a sample for X-ray diffractometry, provided that the other constituent does not mask an X-ray diffraction peak corresponding to the crystal structure of the anode.

Next, the lattice constant of the crystal structure of the active material particle 22 according to the present embodiment is described below. The lattice constant c was estimated to be 1.38 nm (19.3 degrees) from the angle 2θ of a diffraction angle peak specific to the active material particle 22 at 19.3 degrees using the Bragg equation of the general formula (2). Considering that the active material particle 21 containing the stable lithium cobalt oxide has a lattice constant of 1.40 nm (19.0 degrees), it can be shown that the interplanar spacing of the active material particle 22 according to the present embodiment is slightly narrower than the interplanar spacing of the stable active material particle 21.

Bragg equation: c²=λ²(h²+k²+l²)/(4 sin²θ) formula (2)

In the formula (2), A denotes an X-ray wavelength, h, k, and l denote Miller indices (integers) of crystal planes, and θ denotes a Bragg angle.

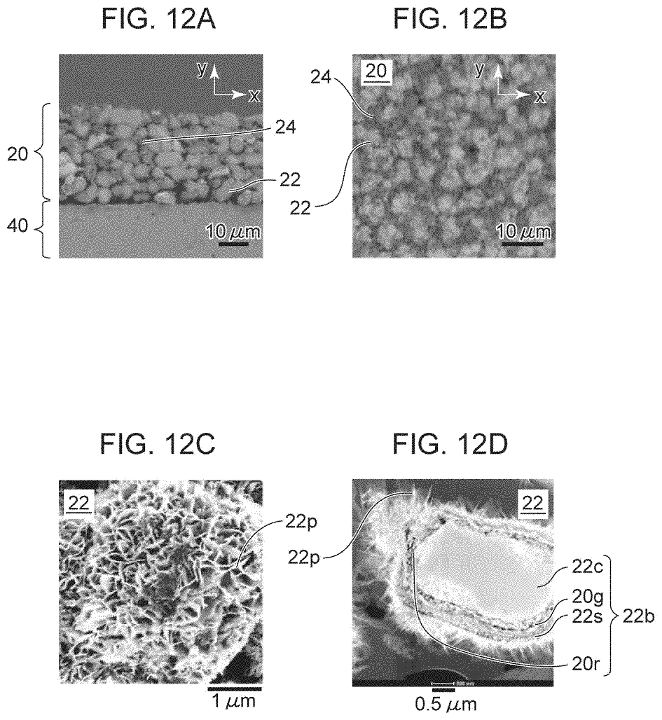

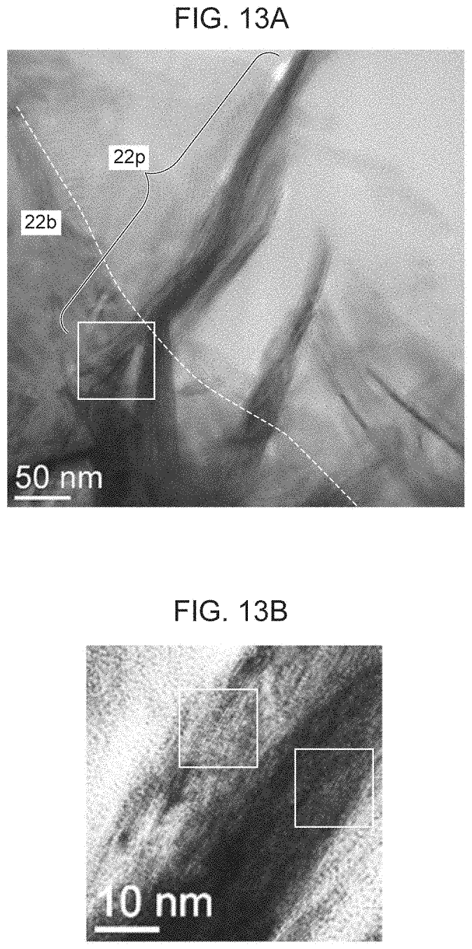

Next, the microscopic structure of the active material particle 22 in the anode 30 according to the present embodiment is described below with reference to micrographs shown in FIGS. 12A to 12D, 13A, and 13B.

FIGS. 12A and 12B are SEM images of a cross section and an upper surface of the anode active material layer 20 according to the third embodiment, respectively. FIGS. 12C and 12D are a SEM image and a cross-sectional TEM image, respectively, showing the appearance of the active material particle 22 according to the third embodiment.

The anode active material layer 20 of FIG. 12A corresponds to the anode active material layer 20 of FIGS. 11A and 11B. As shown in FIGS. 12A and 12B, the anode active material layer 20 contains active material particles 22 containing lithium cobalt oxide LCO and a anode internal electrolyte 24 containing lithium borate LBO in the layer thickness direction and in the layer direction. In FIGS. 12A and 12B, a bright region with a relatively high pixel value corresponding to the intensity of a secondary electron and a backscattered electron from the sample corresponds to the active material particle 22, and a dark region with a relatively low pixel value corresponds to the anode internal electrolyte 24.

As shown in FIGS. 12C and 12D, the active material particle 22 has a particle portion 22b and protrusions 22p protruding radially in a plurality of directions on the outer surface of the particle portion 22b. In the active material particle 22, as shown in FIG. 12D, the inside of the particle portion 22b has a core-shell-like discontinuous texture including a core 22c, a plurality of layered voids 20g, a plurality of shells 22s, and a radial void 20r. The particle portion 22b has an increased specific surface area and is porous in both the inside and the outside thereof, and is different in this point from the active material particle 21 having a plain cross-sectional structure and containing the stable lithium cobalt oxide not subjected to heat treatment described later. The TEM image was acquired in a sample with a slice thickness in the range of 100 to 150 μm at an accelerating voltage of 300 kV.

It is thought that the active material particle 22 according to the present embodiment has the protrusions 22p having a surface with an increased specific surface area and protruding in a plurality of directions, has therefore an increased probability of contact with an electrolyte, and easily transfers an active material ion to and from the electrolyte.

FIG. 13A shows a boundary region between a particle portion and a protrusion of an active material particle according to the third embodiment, and FIG. 13B is a cross-sectional TEM image (lattice image) corresponding to the protrusion. In the present specification, unless otherwise specified, a TEM image and a SEM image are an image taken with a scanning transmission electron microscope and an image taken with a scanning reflection electron microscope. A cross-sectional TEM image was acquired in a sample with a slice thickness in the range of 100 to 150 μm at an accelerating voltage of 200 kV or 300 kV. The sliced sample was prepared with an ion milling apparatus (manufactured by Leica) capable of FIB processing.

The low-magnification image of FIG. 13A is to clearly indicate the position of the high-magnification image of FIG. 13B. FIG. 13A shows that the particle portion 22b is located on the lower left side of the broken line, and a plurality of protrusions 22p protrude from the particle portion 22b. The magnified image of the protrusion 22p in FIG. 13B shows a striped pattern corresponding to the crystal structure of the protrusion 22p along the c-axis. It was found that the observed striped pattern had a plurality of crystallites distributed in the axial direction in which the protrusion 22p protruded. The plurality of crystallite sizes were distributed in the range of 1 nm or more and 20 nm or less. Among the plurality of crystallites, the distance between the stripes of the crystallites in the white frame on the left side of FIG. 13B was 0.47 nm. A size in association with a crystallite is defined by specifying a size in association with the region in a striped pattern arranged in a specific direction of the protrusion 22p. The crystallite may be referred to as a single crystal domain.

On the other hand, the crystallite size determined from a striped pattern of a TEM image of the active material particle 21, which is a virgin commercial product not subjected to the first heating step and the second heating step described later, was in the range of 90 to 100 nm, which was larger than the crystallite size of the active material particle 22. Thus, a comparison between the active material particle 22 and the active material particle 21 with respect to the crystallinity showed that the results of X-ray diffraction angle XRD and a cross-sectional TEM image were consistent.

It is thought that the diffusion coefficient of a Li ion in an active material particle depends on the crystallite size of a lithium cobalt oxide, the distribution of the crystallite orientation, and the specific surface area corresponding to the effective reaction area of the active material particle.

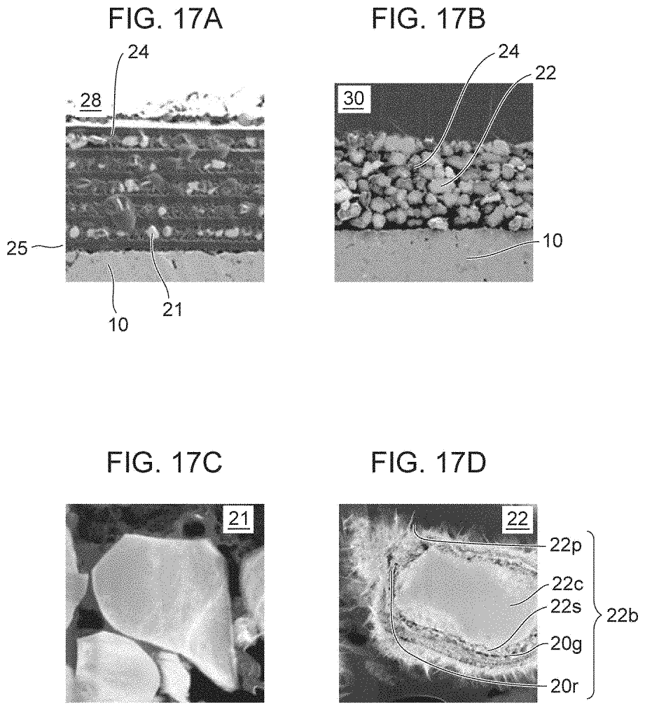

As illustrated in FIGS. 12D and 13A, it is thought that the active material particle 22 with the radial protrusions and made porous has a large effective reaction area for transferring a Li ion to and from an element around the active material particle 22 and efficiently transfers a Li ion. On the other hand, the stable active material particle 21 has a dense particle cross section and a smooth surface as shown in FIG. 17C. It is thought that the active material particle 22 according to the present embodiment has such characteristic morphological features and thereby has high transport ability (mobility) of the active material particle.

Furthermore, as shown in FIGS. 11C and 13B, the active material particle 22 is different from the stable active material particle 21 in that the active material particle 22 has a smaller crystallite size and dispersed orientations. It is thought that a Li ion is transported along a crystallite inside an active material particle, and it is known that the diffusion length of a Li ion inside an active material particles increases as the crystallite size decreases. Thus, it is thought that the active material particle 22 according to the present embodiment has a higher effect of efficiently transporting a Li ion, which is transferred to and from a neighboring element, to the central portion inside the active material particle than the stable active material particle 21. It is thought that the application of the anode 30 containing the active material particle 22 according to the present embodiment to the secondary battery 100 can improve the charge-discharge characteristics.

<Production Steps of Anode and Estimated Modification Mechanism of Active Material Particle>

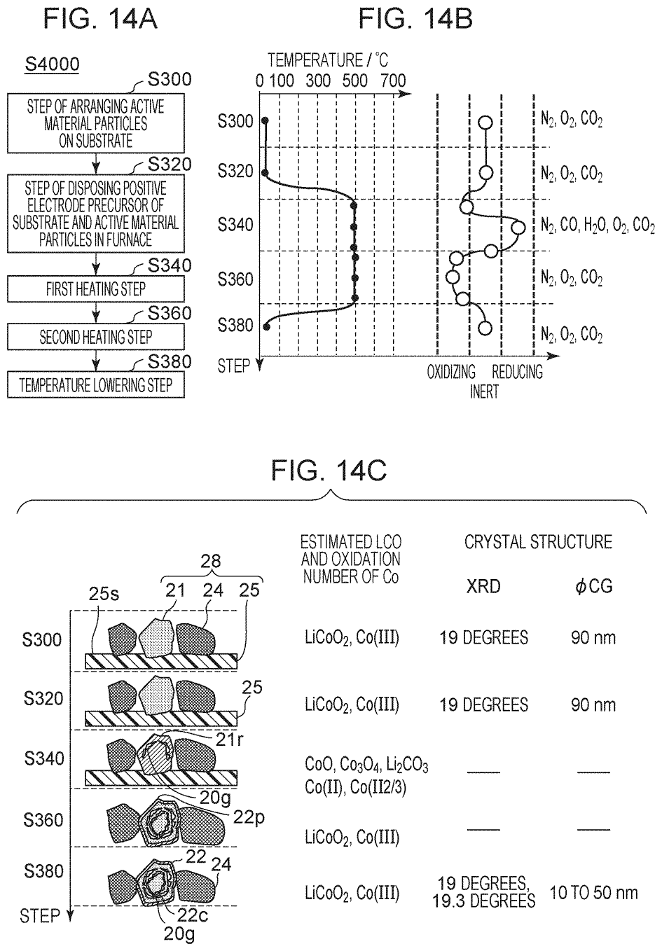

Next, a method for producing the anode 30 according to the present embodiment and a modification mechanism of the active material particle 22 are described below with reference to FIGS. 14A to 17D.

FIG. 14A is a flow chart showing the production sequence of the anode according to the third embodiment, FIG. 14B illustrates an example of a temperature profile, and FIG. 14C illustrates an estimated modification mechanism of an active material particle.

A method S4000 for producing the anode 30 according to the present embodiment is described below with reference to FIG. 14A. The method S4000 for producing the anode 30 includes at least a step S300 of arranging active material particles on a substrate, a step S320 of disposing a anode precursor of the substrate and the active material particles in the inside of a heating furnace, a first heating step S340, a second heating step S360, and a temperature lowering step S380.

Step S300 of Arranging Active Material Particles on Substrate

The present step is the step of arranging active material particles 21, which are precursors of the active material particles 22 constituting the anode 30, on a predetermined surface of a substrate 25. The active material particles 21 can be a particle material of a lithium cobalt oxide, which is a stable commercial product, and correspond to precursors of the active material particles 22 contained in the anode 30. In the present step, the arrangement of the active material particles 21 can be adjusted in the layer direction (the layer surface direction). A laminate of the layer of the active material particles 21 and the substrate 25 may also be referred to as a laminate 28 or a anode precursor 28. When the anode active material layer 20 contains the anode internal electrolyte 24 as illustrated in FIG. 11B, the mixing ratio or the arrangement pattern of the active material particles 21 and the anode internal electrolyte 24 can be adjusted in the present step.

In the present step S300, the anode precursor 28 can be stacked as shown in FIG. 17A. In FIG. 17A, six layers of the anode precursor 28 are stacked on the anode current collector layer 10.

The substrate 25 is formed of a resin material with at least one surface S25 on which the active material particles 21 are disposed. The substrate 25 is a supporting member for supporting the active material particles 21, and the laminate 28 corresponds to the anode precursor 28 in the step S300 to the middle of the first heating step S340.

The present step is performed at room temperature RT (15° C. to 25° C.) in an air atmosphere. When a patterning apparatus or a clean bench is used, the present step may be performed in a specific temperature range in an inert atmosphere purged with an inert gas. To reduce the influence of adsorbed water, an atmosphere of 50° C. or more may be used, or the stage on which the substrate 25 is disposed may be heated.

The substrate 25 can be at least one of a sheet form and a bulk form. From the perspective of the thermal degradability of a resin in the first heating step described later, a sheet form is adopted. A sheet-like substrate 25 may have a flat form, a mesh form, an embossed form, a form with a thickness distribution, or the like. The thickness of the substrate 25 is adjusted to be suitable for the handleability, the average particle size of particles to be supported, the heating time in the first heating step, and the like and can be in the range of 1 μm to 10 mm.

The anode 30 according to the present embodiment is described below in an example in which a PET resin is used for the substrate 25. In the arrangement step S300, a method for arranging the active material particles 21, a conductive aid, and a solid electrolyte 24 in a predetermined pattern on a surface S25 of the substrate 25 can be a known patterning method, such as an ink jet method, a sand painting method, or a mask CVD method, or a deposition method.

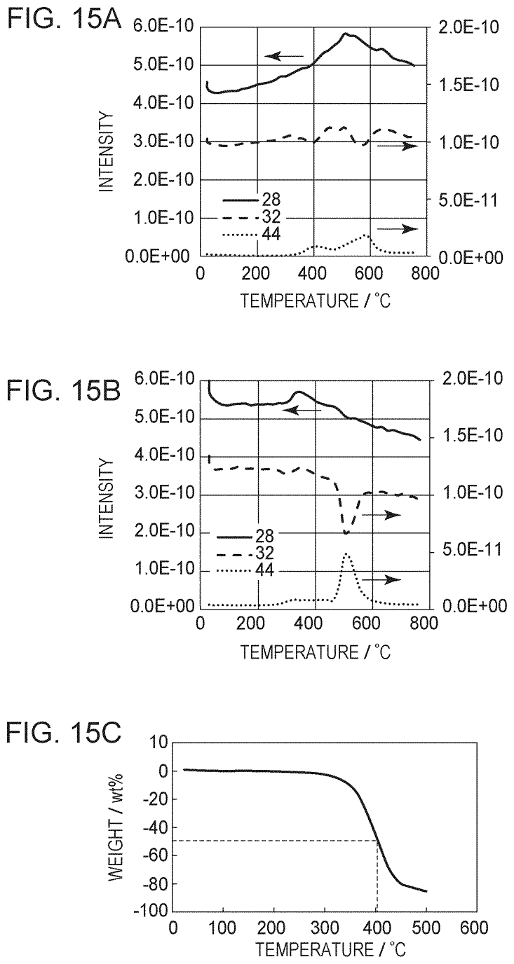

The substrate 25 is selected from materials that can have a solid content of 0 in the first heating step. In other words, a material with a transformation temperature, such as a thermal decomposition temperature or a combustion temperature, depending on the atmosphere and heating profile of the first heating step is selected. When the substrate 25 is a poly(ethylene terephthalate) (PET) resin, as illustrated in FIGS. 15A and 15B described later, the resin 25 is thermally decomposed while releasing a gas with a specific equivalent atomic weight in each temperature range. When the substrate 25 is formed of a PET resin illustrated in FIGS. 15A and 15B, the substrate 25 can be burned to a solid content of 0 in an oxygen-containing atmosphere at a heating temperature of 450° C. or more.

The substrate 25 functions as a supporting member for the active material particles 21 until the solid content of the substrate 25 disappears in a heating preparation step S320 and the first heating step. On the other hand, the substrate 25 plays a plurality of roles as a gas supply source for supplying a reducing gas for reducing the stable active material particles 21 in the first heating step S340 and as a material for adjusting an atmosphere that provides conditions for shifting from the first heating step to the second heating step.

Step S320 of Disposing Anode Precursor of Substrate and Active Material Particle in Furnace

The present step is the step of disposing the substrate 25 and the stable active material particles 21 in a heating furnace. The substrate 25 and the active material particles 21 are integrally disposed in a heating furnace (not shown) as the laminate 28.

The heating furnace may be of a batch type, a continuous type, a single wafer type, or the like, and may be of a type in which a casing is provided to partly cover a heating region for disposing the substrate 25 and the active material particles 21 in order to provide a predetermined atmosphere in a space for heating the substrate 25 and the active material particles 21. In other words, the heating furnace may be of a type in which the gas conductance of a heating region for disposing the substrate 25 and the active material particles 21 is limited in order to set the atmosphere of a space for heating at least the substrate 25 and the active material particles 21 to a predetermined atmosphere. Thus, in the step of heating the laminate 28, when it is desired to efficiently bring a gas lighter than the gas in the atmosphere into contact with the active material particles 22, a casing that mainly covers an upper portion of the heating furnace is effective.

The heating furnace may be of a batch type or a continuous type, which is not completely sealed, and the pressure (the total pressure) of the inside of the furnace in a heating step is considered to be in an isobaric relationship with the surroundings. For safety reasons, the heating furnace may be placed in a room, a workbench, or the like that is evacuated to a slightly negative pressure (0.8 to 0.95 atm). When the heating furnace is in the air, it is thought that the inside of the furnace is maintained at the atmospheric pressure to a slightly negative pressure of the atmospheric pressure in a heating step, and the atmosphere is constituted by nitrogen N₂, which is stable and inert up to a predetermined temperature range.

The present step can be performed at room temperature RT (15° C. to 25° C.) in an air atmosphere as in the arrangement step S300. When a patterning apparatus or a clean bench is used, the present step may be performed in a specific temperature range in an inert atmosphere purged with an inert gas. To reduce the influence of adsorbed water, an atmosphere of 50° C. or more may be used, or the stage on which the substrate 25 is disposed may be heated.

In the third embodiment, both the arrangement step S300 and the heating preparation step S320 are performed at a room temperature of 20° C. in an air atmosphere. Thus, in the arrangement step S300 and the heating preparation step S320, the substrate 25 and the active material particles 21 are in an air atmosphere containing nitrogen, oxygen, and carbon dioxide.

First Heating Step S340

The present step is the step of heating the anode precursor 28 until the substrate 25 is thermally decomposed to a solid content of 0. In this step, the substrate 25 contained in the anode precursor 28 includes the step of releasing a reducing gas and bringing the released gas into contact with the active material particles 21. In other words, the first heating step S340 includes the step of heating the active material particles 21 in a reducing atmosphere containing a reducing gas released by thermal decomposition of a resin contained in the substrate 25. In other words, the first heating step S340 is performed until the atmosphere of the inside 82 of the heating furnace becomes an oxidizing atmosphere in which a reducing gas derived from a resin contained in the substrate 25 is decreased and the partial pressure of an oxidizing gas containing oxygen exceeds the partial pressure of the reducing gas. The first heating step S340 in the present embodiment is started in an oxygen-containing atmosphere containing oxygen O₂. The heating temperature in the first heating step S340 in the present embodiment can be 300° C. or more and 690° C. or less.

The present inventors assume that, in the first heating step S340, the active material particles 21 are subjected to a thermal reduction reaction with carbon monoxide CO derived from the substrate 25, which reduces cobalt Co and makes the microstructure in the particle porous.

Second Heating Step S360

The present inventors have assumed that, in the second heating step S360, a reduced active material particle 21r has a fine structure and a crystal structure different from those of stable LCO, although the cobalt is oxidized and returned to LCO by oxygen in the atmosphere instead of carbon monoxide the supply of which has been stopped. The heating temperature in the second heating step S360 can be 400° C. or more and 690° C. or less.

The reasons for these are described below with reference to FIGS. 15A, 15B, 16A to 16C, and 17A to 17C.

FIGS. 15A and 15B show the results of differential thermal analysis. FIG. 15A is a differential thermal analysis DTA profile of a sheet-like PET resin used for the substrate 25. In the figure, the solid line is a DTA curve for an equivalent atomic weight of 28 (left axis), the broken line is a DTA curve for an equivalent atomic weight of 32 (right axis), and the dotted line is a DTA curve for an equivalent atomic weight of 44 (right axis). The equivalent atomic weight of 28 may be nitrogen N₂ or carbon monoxide CO. However, nitrogen gas is unlikely in consideration of the DTA curve profile that increases at room temperature to 520° C. and decreases at 520° C. or more, the composition of the PET resin, and the analysis environment. Thus, the solid line profile is considered to be carbon monoxide CO. The broken and dotted line profiles are considered to be oxygen O₂ and carbon dioxide CO₂, respectively, for the same reasons.

FIG. 15A shows that the PET resin is gradually thermally decomposed by heating from room temperature and releases carbon monoxide CO with a peak around 520° C. Furthermore, oxygen and carbon dioxide showing qualitatively opposite trends in increase and decrease show that part of carbon monoxide CO or part of carbon constituting the PET resin consumes oxygen in the atmosphere and is converted into carbon dioxide CO₂. Carbon dioxide CO₂ begins to increase mainly at higher temperatures than carbon monoxide CO and reaches a peak at approximately 590° C.

On the other hand, the thermal decomposition temperature of the PET resin used for the substrate 25 was approximately 400° C. as defined by the solid content 50% reduction temperature in the thermogravimetric analysis TG profile shown in FIG. 15C.

Thus, it can be considered that the first heating step S340 performed until the substrate 25 is burned includes the step of bringing a reducing carbon monoxide CO gas released from the substrate 25 into contact with the stable active material particles 21.

Next, FIG. 15B is a differential thermal analysis DTA profile of the laminate 28 of a sheet-like PET resin corresponding to FIG. 15A and a layer containing a plurality of stable active material particles 21.

In FIG. 15B, carbon monoxide CO, which increases with the temperature in the temperature range of 520° C. or less in the case of the PET resin alone, starts to decrease at 350° C. or more. It is therefore assumed that part of carbon monoxide derived from the PET resin is consumed in a thermal reduction reaction of LCO at 350° C. or more. More specifically, it is assumed from FIG. 15B that the stable lithium cobalt oxide is thermally decomposed by carbon monoxide CO at 350° C. or more. When the PET resin is fired together with the active material particle 21 containing LCO, it is assumed that at least part of carbon monoxide CO released is immediately consumed in the thermal reduction reaction of LCO at 350° C. or more and is directly oxidized to carbon dioxide CO₂ by the surrounding oxygen at 510° C. or more. Thus, in the first heating step S340, it is assumed that at least part of carbon monoxide CO derived from the resin 25 is immediately consumed in the thermal reduction reaction of LCO at 350° C. or more and is consumed to produce carbon dioxide CO₂ at 510° C. or more.

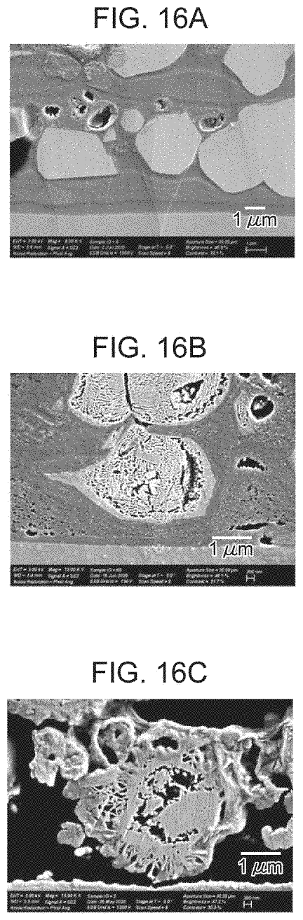

The present inventors investigated the heating temperature dependency of the laminate 28 (the anode precursor 28) in an air atmosphere. FIGS. 16A to 16C show a cross-sectional SEM image of the laminate 28 fired at a heating temperature of 300° C., 400° C., and 500° C., respectively, for one hour in an air atmosphere. In FIGS. 16A to 16C, a region in the form of an approximately round particle with a bright pixel value is a region corresponding to the active material particle 21 or the active material particle 22. In the SEM samples of FIGS. 16A and 16B, due to insufficient sintering between the active material particles 21, the periphery of the active material particles 21 is solidified with a mold resin for sample preparation. Thus, the resin continuously spreading around the active material particles 21 in FIGS. 16A and 16B may be ignored during observation. On the other hand, the active material particles 22 in the sample of FIG. 16C are sintered and integrated, and no mold resin is present in the figure.

As illustrated in FIG. 16A, the active material particles 21 subjected to the heating conditions at 300° C. have the same uniform cross section as a cross section of stable LCO (FIG. 17C described later). It can be seen that, although the active material particles subjected to the heating conditions at 400° C. in FIG. 16B have a more porous cross section than those in FIG. 16A, the protrusions are not significantly grown.

On the other hand, the active material particles 22 subjected to the heating conditions at 500° C. in FIG. 16C have a porous structure and protrusions protruding from the particle portion in a plurality of directions.

When the crystal structure of XRD samples of the same heating temperature level as the SEM samples of the different heating temperatures was examined, cobalt oxide (CoO/Co₃O₄) was detected only in the sample of 400° C. The crystal structure of lithium cobalt oxide LiCoO₂ was identified in the samples of 300° C. and 500° C. Thus, when heated at 400° C., Co had an oxidation number II or II2/3, and the oxidation number III of Co in lithium cobalt oxide LiCoO₂ was reduced. It was also found that lithium cobalt oxide LiCoO₂ in the sample subjected to a heating temperature of 500° C. was cobalt oxide (CoO/Co₃O₄) once reduced and then reoxidized.

It was assumed that the reoxidation was performed by oxygen that was present in the firing atmosphere and that was active at a high temperature of 500° C., instead of by reducing carbon monoxide CO the supply of which was stopped by the combustion of the PET resin. This reoxidation step corresponds to the second heating step S360 performed after the reduction reaction of the first heating step S340.

Thus, the heating conditions at 500° C. corresponding to FIG. 17C are considered to be the first heating step S340 in the first half and the second heating step S360 in the second half.

On the other hand, when a sample equivalent to the sample subjected to the firing conditions at 500° C. in FIG. 17C was heated at 700° C. for 10 minutes, in the cross-sectional SEM image (not shown) of the sample, the inside of an active material particle had a homogeneous structure and had the morphology of a stable LCO as shown in FIG. 17A. The porous structure containing the protrusion 22p and the layered void 20g was lost by firing in the heating step at 700° C. Thus, it is thought that an oxidation reaction and a melt reaction proceeded excessively at 700° C. or more, thus resulting in a stable LCO without a fine structure or a characteristic crystal structure.

Thus, in the second heating step of reoxidizing the active material particle 21r reduced in the first heating step, the heating temperature is set to 690° C. or less to prevent oxidation and melting from proceeding to a stable LCO.

As described above, the resin in the substrate 25 functions as a gas supply source for reducing the active material particle 21 in the first heating step and also functions as an atmosphere adjusting material for changing the atmosphere from the first heating step to the second heating step.

On the basis of the analysis results of FIGS. 15A to 17D, FIGS. 14B and 14C illustrate a figure of each step drawn by the present inventors. FIGS. 14A to 14C illustrate estimated mechanisms corresponding to the steps S300 to S380.

In the arrangement step S300 and the heating preparation step S320, there is no significant structural change in the laminate 28 (the anode precursor 28).

In the first heating step S340, the laminate 28 is heated to 500° C. The substrate 25 releases carbon monoxide CO at the beginning of the first heating step S340 and is thermally decomposed while releasing carbon dioxide CO₂ in the second half. The released carbon monoxide CO reduces cobalt in the active material particle 21 from a valence of II to a valence of III, modifies at least part of LCO to cobalt oxide (CoO/Co₃O₄), and modifies the active material particle 21 to a reduced active material particle 21r with a fine structure in which the inside of the particle is made porous. The carbon monoxide CO is closer to the active material particle 21 than the oxygen O₂ present in the atmosphere, and the carbon monoxide CO released from the substrate 25 dominates as an active gas of the heating atmosphere and is consumed for the modification of the LCO at the beginning of the first heating step S340. In the late stage of the first heating step S340, when the substrate 25 is gradually thermally decomposed and the supply of carbon monoxide CO is stopped and replaced with the supply of inert carbon dioxide CO₂, the atmosphere of the first heating step S340 shifts from reducing to inert.

Furthermore, in the second heating step S340, when the combustion of the resin contained in the substrate 25 is completed to also completely stop the supply of the carbon dioxide CO₂, the consumption of oxygen O₂ is stopped, and oxygen O₂ active at high temperatures reoxidizes the active material particle 21. Thus, the atmosphere in the second heating step S360 is dominated by high-temperature oxygen O₂ and is shifted from inert to oxidizing.

In the second heating step S360, the oxidation number of at least part of the cobalt Co in the active material particle changes from II or II2/3 to III. In the second heating step S360, it is thought that the oxidation reaction does not proceed completely in the particle, and the layered void 22g formed in the first heating step and the protrusion 22p formed in the first half of the second heating step remain even after the temperature lowering step S380. The phrase “the oxidation reaction does not proceed completely” may be expressed as “an incomplete oxidation reaction proceeds” or “a local oxidation reaction proceeds”.

When only the level of the temperature rising rate in the first heating step S340 was changed and the other steps were performed under the same conditions as in the third embodiment, an active material particle with the same fine structure and crystal structure as those of the active material particle 22 of the third embodiment was produced at a temperature rising rate of 10° C./min or less. At a temperature rising rate of more than 10° C./min, an active material particle thus produced did not have the same fine structure and crystal structure as those of the active material particle 22 of the third embodiment. It is thought that such temperature rising rate dependency requires that the laminate 28 remains for 20 minutes or more in the temperature range of 300° C. or more and 500° C. or less in which carbon monoxide CO is generated from the substrate 25 in the first heating step. It is assumed that, when the temperature rising rate is more than 10° C./min and the dwell time of the laminate 28 in the temperature range of 300° C. to 500° C. is less than 20 minutes, the PET resin is rapidly and completely burned, inert carbon dioxide CO₂ is supplied from the beginning of the heating step, and carbon monoxide CO is insufficiently supplied. The second heating step S360 can be performed at 400° C. or more and 690° C. or less for 10 minutes or more and 90 minutes or less.

Temperature Lowering Step S380

The present step is the step of lowering the temperature of the active material particle 22 reoxidized after reduction to form the anode active material layer 20 in which the modified active material particles 22 are solidified and sintered. The laminate 28 with a cross section as shown in FIG. 17A in the arrangement step S300 has a cross section as shown in FIG. 17B through the present step S380 and maintains the macroscopic structure. After the second heating step S360, which is a local oxidation reaction, as illustrated in FIG. 14C, a fine structure of an active material particle formed in S340 to S360 is retained in the present step S360.

### Fourth Embodiment

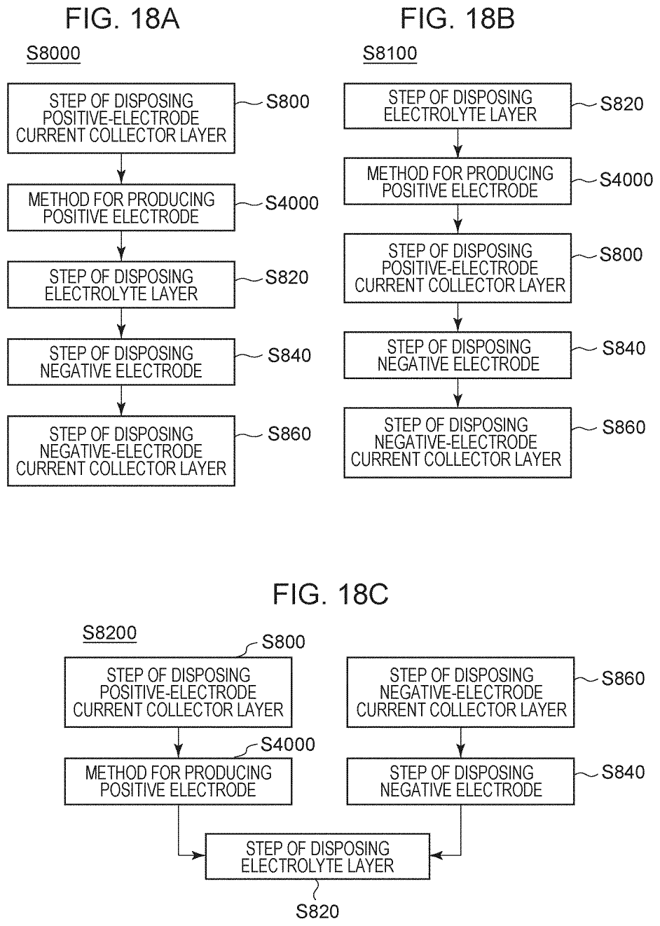

The present embodiment shows a method for producing a secondary battery 100 (solid-state battery 100) as illustrated in FIG. 11A using the anode 30 according to the third embodiment. The method for producing the secondary battery 100 is described below with reference to FIGS. 18A to 18C.

FIG. 18A is a flow chart of a method S8000 for producing a secondary battery according to a fourth embodiment.

The method S8000 for producing a secondary battery according to the present embodiment includes a step S800 of disposing a anode current collector layer, a method S4000 for producing a anode, a step S820 of disposing an electrolyte layer, a step S840 of disposing a cathode, and a step S860 of disposing a cathode current collector layer. These steps are performed in this order.

In a modified example of the present embodiment, a composite precursor can be formed by stacking at least any two adjacent elements of the anode current collector layer 10, the anode active material layer 20, the electrolyte layer 40, the cathode active material layer 50, and the cathode current collector layer 60 via the substrate 25. Also in such a modified example, the composite precursor can be used to produce the secondary battery 100 in which a plurality of elements are stacked in accordance with the method for producing a anode described in the third embodiment. Thus, as a modified example of the method S8000 for producing the secondary battery 100 according to the fourth embodiment, the present invention includes, as a modified example of the fourth embodiment, an embodiment in which each of the steps S800 to S860 is performed in accordance with the method S4000 for producing a anode according to the third embodiment.

FIG. 18B is a flow chart of a method S8100 for producing a secondary battery according to a modified example of the fourth embodiment. In the present modified example, as illustrated in FIGS. 21-1 and 21-2, a composite laminate is prepared by stacking a laminate containing a plurality of electrolyte particles as a precursor of a solid electrolyte layer 40 arranged on a substrate and a laminate containing active material particles as a precursor of a anode active material layer 20 and a anode internal electrolyte arranged on a substrate. The present modified example is different from the fourth embodiment in that the order of stacking the anode current collector layer 10, the anode active material layer 20, and the electrolyte layer 40 is reversed. Thus, the step of stacking a constituent element of the secondary battery 100 and another adjacent element can be performed in reverse order or simultaneously without damaging the other element.

FIG. 18C is a flow chart of a method S8200 for producing a secondary battery according to another modified example of the fourth embodiment. The method S8200 for producing a secondary battery described in the present modified example is different from S8000 of the fourth embodiment and S8100 of the modified example thereof in that the anode 30 and the cathode 70 are prepared in parallel prior to lamination on the electrolyte layer 40.

Cathode

The cathode may be produced by a known method. As in the modified example of the fourth embodiment of the present application, the method for producing the anode 30 according to the third embodiment may be applied to produce the cathode. Like the anode 30, the cathode may be formed of a particle containing a cathode active material or may be produced by forming a film of a metal, such as metallic Li or In—Li.

Electrolyte

A solid electrolyte, a liquid electrolyte, or the like may be used as an electrolyte. For a solid-state battery containing a solid electrolyte, the electrolyte may be produced in the same manner as in the anode or may be produced by a known method. The known method may be, but is not limited to, a coating process, a powder pressing process, a vacuum process, or the like, as in the cathode. The electrolyte may be produced independently or may be produced collectively as a laminate of the electrolyte and a anode or a cathode or a laminate of the electrolyte, a anode, and a cathode. A liquid electrolyte or a polymer electrolyte produced by a production method different from the production methods of the electrodes may be produced by any method.

[Solid Electrolyte]

The solid electrolyte is, for example, an oxide solid electrolyte, a sulfide solid electrolyte, a complex hydride solid electrolyte, or the like. The oxide solid electrolyte may be a NASICON-type compound, such as Li_{1.5}Al_{0.5}Ge_{1.5}(PO₄)₃ or Li_{1.3}Al_{0.3}Ti_{1.7}(PO₄)₃, or a garnet-type compound, such as Li_{6.25}La₃Zr₂Al_{0.25}O₁₂. The oxide solid electrolyte may be a perovskite compound, such as Li_{0.33}Li_{0.55}TiO₃. The oxide solid electrolyte may be a LISICON-type compound, such as Li₁₄Zn(GeO₄)₄, or an acid compound, such as Li₃PO₄, Li₄SiO₄, or Li₃BO₃. Specific examples of the sulfide solid electrolyte include Li₂S—SiS₂, LiI—Li₂S—SiS₂, LiI—Li₂S—P₂S₅, LiI—Li₃PO₄—P₂S₅, and Li₂S—P₂S₅. The solid electrolyte may be crystalline or amorphous and may be a glass ceramic. The term “Li₂S—P₂S₅” or the like refers to a sulfide solid electrolyte produced by using a raw material containing Li₂S and P₂S₅.

[Liquid Electrolyte]

The liquid electrolyte is, for example, a nonaqueous electrolyte solution. The nonaqueous electrolyte solution is a liquid containing approximately one mole of lithium salt dissolved in a nonaqueous solvent. The nonaqueous solvent may be ethylene carbonate, propylene carbonate, dimethyl carbonate, diethyl carbonate, or ethyl methyl carbonate. The lithium salt may be LiPF₆, LiBF₄, or LiClO₄. An aqueous electrolyte solution containing a water medium may also be used.

[Cathode Active Material]

The cathode active material is, for example, a metal, metal fiber, a carbon material, an oxide, a nitride, silicon, a silicon compound, tin, a tin compound, an alloy material, or the like. Among these, a metal, an oxide, a carbon material, silicon, a silicon compound, tin, a tin compound, or the like is preferred in terms of the capacity density. The metal is, for example, metallic Li or In—Li. The oxide is, for example, Li₄Ti₅O₁₂ (LTO: lithium titanate) or the like. The carbon material is, for example, natural graphite (graphite), coke, graphitizing carbon, carbon fiber, spherical carbon, artificial graphite, amorphous carbon, or the like. The silicon compound is, for example, a silicon-containing alloy, a silicon-containing inorganic compound, a silicon-containing organic compound, a solid solution, or the like. The tin compound is, for example, SnO_{b} (0<b<2), SnO₂, SnSiO₃, Ni₂Sn₄, Mg₂Sn, or the like. The cathode material may contain a conductive aid. The conductive aid is, for example, graphite, such as natural graphite or artificial graphite, or carbon black, such as acetylene black, Ketjen black, channel black, furnace black, lampblack, or thermal black. The conductive aid may be electrically conductive fiber, such as carbon fiber, carbon nanotube, or metal fiber, a fluorocarbon, a metal powder, such as aluminum, electrically conductive whisker, such as zinc oxide, an electrically conductive metal oxide, such as titanium oxide, an organic electrically conductive material, such as a phenylene dielectric, or the like.

Another Embodiment of Cell Formation of Anode

The assembly of a secondary battery, that is, the cell formation of a anode can be performed by a known method for producing a laminated cell type, a coin cell type, a pressurized cell type, or the like. A typical laminated cell type is described below as an example.

Assembly of Laminated Cell

The assembly of a laminated cell is described below with respect to an all-solid-state battery or a polymer battery. A anode, an electrolyte, and a cathode produced by the production methods described above are stacked between a anode current collector and a cathode current collector. Each current collector is welded to an extraction electrode tab at an end portion thereof. The laminate of the current collectors, the anode, the electrolyte, and the cathode is placed on an Al laminated film, is wrapped with the Al laminated film, and is sealed under vacuum using a vacuum packaging machine. Although the electrode tabs are extracted from the laminated film, the tabs and the Al laminated film are bonded by thermocompression bonding, so that the sealing is maintained. If necessary, the sealing may be followed by pressurization with an isostatic pressing apparatus or the like. The electrolyte may be a solid electrolyte or a polymer electrolyte and may be a laminate of the solid electrolyte and the polymer electrolyte. In addition to the laminate described above, the Al laminated film may include an elastic material layer or a resin material layer for the purpose of strengthening, forming, or the like. Furthermore, a bipolar type (in series/in parallel) in which a plurality of the laminates are stacked may also be used. In a known lithium-ion battery containing a liquid electrolyte, a polyethylene separator is used instead of the electrolyte. A liquid electrolyte is injected and sealed before sealing with a vacuum packaging machine.

### Fifth Embodiment

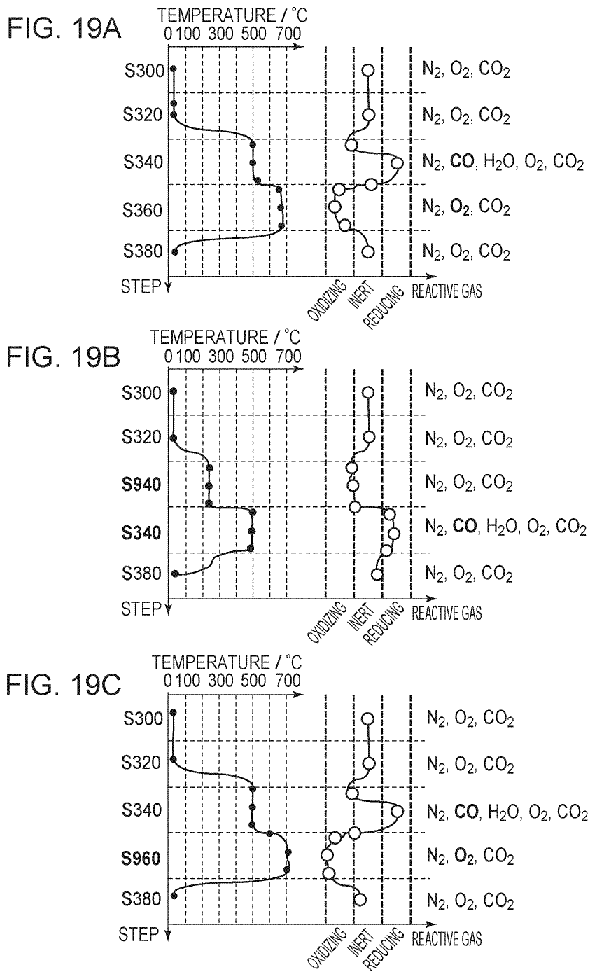

Next, a method for producing each anode according to a fifth embodiment and a reference embodiment is described below with reference to FIGS. 19A to 19C.

FIG. 19A illustrates an estimated change in atmosphere for each step in a method for producing a anode according to the fifth embodiment. Likewise, FIGS. 19B and 19C illustrate an estimated change in atmosphere for each step in production methods according to two modified embodiments in which the structure of the anode as in the first embodiment of the present application could not be obtained. In FIGS. 19A to 19C, as in FIG. 14B, the estimated atmosphere is represented by the properties of oxidizing, inert (neutral), and reducing reactive gases based on the estimation of a main component of a reactive gas from the temperature of a heating step and from the results of differential thermal analysis. The reactivity increases with the distance from the centerline of a band indicating an inert region.

The method for producing a anode according to the fifth embodiment is different from the method for producing a anode according to the third embodiment (500° C.) in that the heating temperature in the second heating step S360 is 680° C. Even when the heating temperature in the second heating step S360 is 680° C., the reoxidation in the second heating step S360 proceeds although the reoxidation does not proceed uniformly and homogeneously. Also in the present embodiment, the heating time in the second heating step can be equal to or shorter than the heating time in the heating step S340 of the third embodiment to match a reactive gas component estimated based on FIGS. 15A to 15C to that in each step of the third embodiment. The anode 30 with a fine structure and a crystal structure similar to those of the active material particle 22 of the third embodiment can also be produced in the fifth embodiment.

A reference embodiment illustrated in FIG. 19B is different from the method for producing the anode 30 according to the third embodiment in that a third heating step S940 at a heating temperature of 250° C. is performed instead of the first heating step S340. In the third heating step S940, the heating temperature is insufficient for the PET resin, and the substrate 25 is not thermally decomposed. Thus, carbon monoxide CO is not sufficiently generated, and the atmosphere is assumed to be slightly oxidizing at 250° C. due to a reactive gas oxygen. In a method for producing a anode according to a reference embodiment illustrated in FIG. 19B, the second heating step S360 following the third heating step S940 substantially corresponds to the first heating step S340 of the third embodiment. In other words, the method for producing a anode according to the reference embodiment illustrated in FIG. 19B is different from the method for producing the anode 30 according to the third embodiment in that the second heating step S360 after the first heating step S340 is not provided.

Thus, a laminate 28 subjected to the method for producing a anode according to the reference embodiment illustrated in FIG. 19B was not subjected to a reoxidation reaction corresponding to the second heating step S360 and therefore had a cross-sectional profile equivalent to that of the active material particle 21r subjected to heating at a heating temperature of 400° C. in FIG. 16B. Thus, the laminate 28 subjected to the method for producing a anode according to the reference embodiment illustrated in FIG. 19B was not subjected to a reoxidation step corresponding to the second heating step S360 and therefore had a crystal structure (XRD profile) similar to that of the active material particle 21r corresponding to FIG. 16B. Thus, the anode 30 produced in the third embodiment was not produced by the method for producing a anode according to the present reference embodiment.

A reference embodiment illustrated in FIG. 19C is different from the method for producing the anode 30 according to the third embodiment in that a fourth heating step S960 at a heating temperature of 700° C. is performed instead of the second heating step S360. The heating time is the same in the fourth heating step S960 and in the second heating step S360. The reduced active material particle 21r was sufficiently (uniformly) oxidized at the heating temperature in the fourth heating step S960, and an active material particle subjected to the temperature lowering step S380 therefore had the cross-sectional profile of the stable active material particle 21, which was a starting material. The reduced active material particle 21r was sufficiently (uniformly) oxidized at the heating temperature in the fourth heating step S960, and an active material particle subjected to the temperature lowering step S380 therefore did not have the characteristics of the active material particle 22 according to the third embodiment. Thus, the anode 30 produced in the third embodiment was not produced by the method for producing a anode according to the present reference embodiment.

### Fourth Embodiment

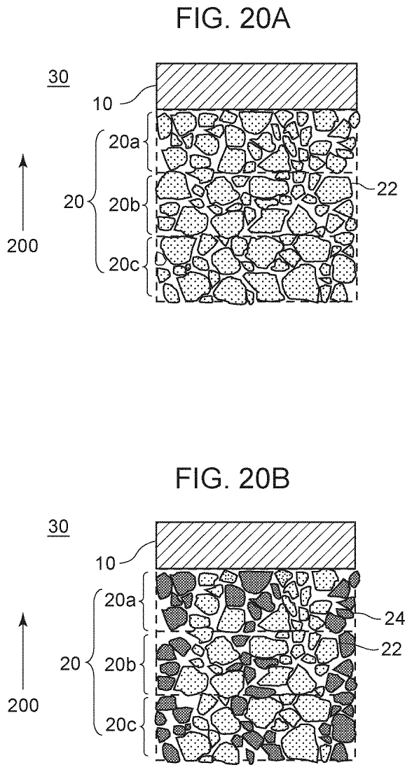

Next, the layered structure of a anode according to the fourth embodiment or a modified embodiment thereof is described below with reference to FIG. 20A. FIG. 20A is a schematic cross-sectional view of the anode according to the fourth embodiment, and FIG. 20B is a schematic cross-sectional view of the anode according to the modified embodiment thereof.

A anode 30 illustrated in FIG. 20A is different from the anode 30 according to the third embodiment in that the anode active material layer 20 is constituted by a plurality of active material particles 22 containing lithium cobalt oxide without using the anode internal electrolyte 24. The anode 30 according to the present embodiment was produced through the steps according to the third embodiment except that only the stable active material particles 21 were arranged without a precursor of the anode internal electrolyte 24 in the arrangement step S300 in the method S4000 for producing the anode 30.

The anode 30 according to the modified embodiment illustrated in FIG. 20B is different from the anode 30 according to the third embodiment in that the active material particle 22 and the anode internal electrolyte 24 are arranged in a predetermined pattern in the layer and that pattern phases are aligned between the anode active material layers 20a and 20b. The pattern in each layer of the anode active material layers 20a and 20b is repeated in a delta arrangement so that the active material particle 22 forms a circular isolated island, and the space between the islands of the active material particles 22 is continuously filled with particles of the anode internal electrolyte 24.

The anode 30 according to the present embodiment was produced through the steps according to the third embodiment except that precursor particles of the anode internal electrolyte 24 and the stable active material particles 21 were patterned in the arrangement step S300 in the method S4000 for producing the anode 30.

### EXAMPLES

An all-solid-state battery in the present example contained a lithium cobalt oxide (CELLSEED C-5H, manufactured by Nippon Chemical Industrial Co., Ltd.) as a anode active material and an In—Li foil (manufactured by Nilaco Corporation) as a cathode active material. The all-solid-state battery in the present example contained lithium borate (manufactured by Toshima Manufacturing Co., Ltd.) as a solid electrolyte for a anode mixture and Li_{1.5}Al_{0.5}Ge_{1.5}(PO₄)₃ (manufactured by Toshima Manufacturing Co., Ltd.) as a solid electrolyte for a electrolyte. The electrolyte was formed into pellets using a uniaxial pressing apparatus and was air-sintered (at 850° C. for 12 hours) in an electric furnace to prepare and use an electrolyte sheet Sh with a thickness of 260 μm. The electrolyte sheet Sh had an ionic conductivity of 2.5×10⁻⁴ S/cm at room temperature. Lithium cobalt oxide is hereinafter abbreviated to LCO, lithium borate is abbreviated to LBO, and Li_{1.5}Al_{0.5}Ge_{1.5}(PO₄)₃ is abbreviated to LAGP.

A known lithium-ion battery containing a liquid electrolyte contained a lithium cobalt oxide (CELLSEED C-5H, manufactured by Nippon Chemical Industrial Co., Ltd.) as a anode active material, a metallic Li foil (in-house formed) as a cathode active material, and a polyethylene separator as a separator. The known lithium-ion battery containing a liquid electrolyte contained 1 mol/L LiPF₆ EC:DEC=1:1 (% by volume) as an electrolyte solution. A secondary battery of a laminated cell type was assembled and included an Al laminated film (manufactured by Dai Nippon Printing Co., Ltd.) as a laminated film, an Al foil (manufactured by Nilaco Corporation) as a anode current collector, a Cu foil (manufactured by Nilaco Corporation) as a cathode current collector, and an Al tab with a sealant (manufactured by Hohsen Corp.) as a anode tab. The secondary battery of the laminated cell type assembled also included a CuNi tab with a sealant (manufactured by Hohsen Corp.) as a cathode tab.

### Example 1

<Process of Forming all-Solid-State Battery>

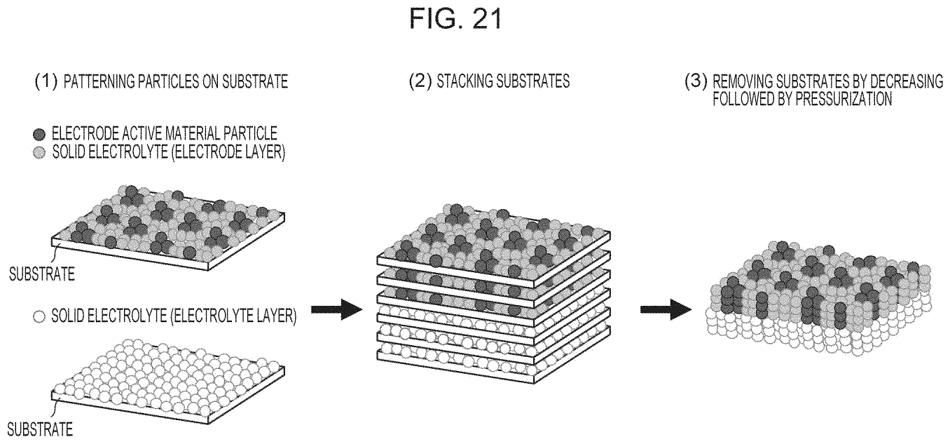

A process of forming a secondary battery (all-solid-state battery) according to the present example is described with reference to FIG. 21.

The process of forming the secondary battery (all-solid-state battery) according to the present example illustrated in FIG. 21 includes at least the following steps S1, S2, and S3.

S1: Particles (an active material, a solid electrolyte, and the like) are arranged in a pattern in a single layer on a substrate.

S2: Substrates on which the monolayer particles are arranged are stacked.

S3: The substrates are removed by degreasing, and the laminate is pressed.

The substrate is a temporary substrate to densely arrange particles in a plane in a single layer and can be a material to be removed by heat treatment in a subsequent step. Although FIG. 21 illustrates an example of integral forming of a anode and an electrolyte, the same can be applied to integral forming including a cathode and a current collector, the formation of a anode and a cathode on a current collector, or the formation of a anode and a cathode on an electrolyte sheet produced by another process. In the present forming process, the size and shape can be controlled, and, in principle, the thickness of an electrode or an electrolyte can also be controlled on the level of one particle depending on the number of substrates to be stacked.

A secondary battery produced by the forming process of the present example is described below.

In the step S1, the anode or the cathode is disposed so that the active material particles of the anode or the cathode are in contact with the solid electrolyte by adjusting the pattern or the lamination position on the substrate depending on the particle size of the active material or the solid electrolyte used. Furthermore, for the intra-layer pattern and the lamination pattern as illustrated in FIG. 21, it is thought that the particles of the solid electrolyte have a mesh-like network structure in the layer (in-plane), and stacking the network structure can easily form an ionic conduction path in the in-plane direction and in the lamination direction. The mesh-like network may also be referred to as network-like or mesh-like. The number of substrates to be stacked can be adjusted to control the film thickness of the anode or the cathode.

On the other hand, an electrolyte layer is formed by stacking a precursor of a monolayer electrolyte layer, in which particles of a solid electrolyte are densely arranged on a substrate containing a sheet-like resin. The thickness of the electrolyte layer can be controlled and decreased on the basis of the average particle size of one particle. The present inventors have confirmed that a solid electrolyte layer with a thickness of approximately 20 μm can be formed. As described above, the present forming process can achieve both the formation of an ionic conduction path in the anode and the cathode and a decrease in the thickness of the electrolyte.

<Process for Producing Battery>

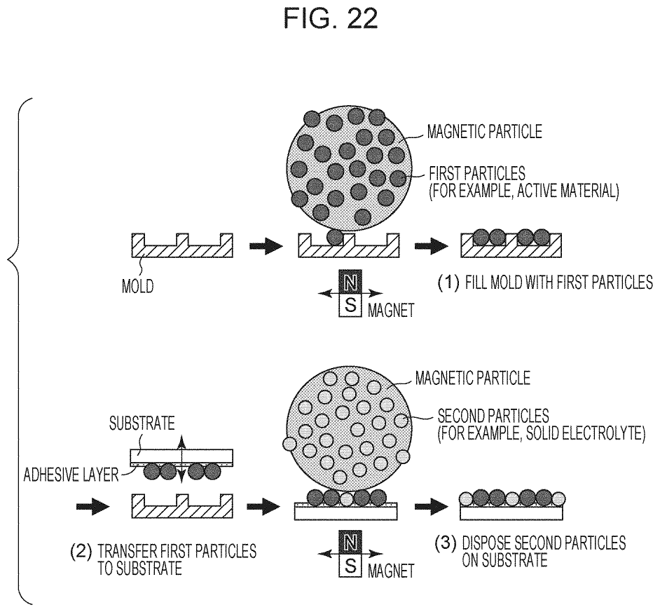

A process flow for producing the secondary battery according to the present example is described below with reference to FIGS. 22 to 26.

Active Material Particles and Patterning of Active Material Particles

A patterning method is illustrated in FIG. 22. A method for patterning a precursor of the anode in the secondary battery according to the present example includes the following three steps SS1 to SS3. The steps SS1 to SS3 correspond to the step S1 and to the arrangement step S300 in the third embodiment.
SS1: Fill a concave mold with first particles.
SS2: Transfer the first particles to a substrate on which an adhesive layer is applied.
SS3: Fill a region to which no first particles are transferred with second particles.

Each of the steps SS1 to SS3 is described below with reference to FIG. 22.

Step SS1

The concave mold with a plurality of recessed portions has an uneven structure in a predetermined pattern. The recessed portions can have an opening width at which the recessed portions can be filled with the first particles (for example, active material particles) and a depth equal to or smaller than the average particle size of the first particles (active material particles). The raised portions have a width equal to or larger than the average particle size of the second particles (solid electrolyte). Magnetic particles larger than the opening width of the recessed portions were charged to support the first particles and were supplied onto the concave mold. The magnetic particles supporting the first particles were rubbed on the concave mold with a magnet placed directly under the concave mold. The magnetic particles were rubbed under a strong attractive force applied in a vertically downward direction with respect to the mold, and the first particles restrained in fine recessed portions were removed from the magnetic particles and were selectively filled in the recessed portions. Furthermore, the step SS1 has an effect of crushing aggregated first particles and a classification effect of eliminating a coarse powder. To prepare the mold, a master mold was prepared in a semiconductor process in our company, and a concave mold for verification was duplicated by an imprint method.

Step SS2

A substrate with an adhesive layer applied to a surface thereof was pressed against the concave mold filled with the first particles (active material particles) and was peeled off to transfer only the first particles (active material particles) to the substrate by the adhesive force of the adhesive layer while the monolayer pattern was maintained. The substrate was a poly(ethylene terephthalate) (PET) substrate, which was removed by degreasing in a subsequent step.

Step SS3

The substrate to which the first particles have been transferred is filled with the second particles (solid electrolyte) by the rubbing method as in the step SS1. The adhesive layer is exposed on the substrate on which the first particles (active material particles) are not arranged, and the first particles on the substrate form raised portions and constitute an uneven structure. Recessed portions in which the first particles were not arranged were filled with the second particles. In FIG. 22, although the first particles and the second particles have similar particle sizes for the sake of explanation, a portion where the first particles are not arranged can be filled with multilayer second particles with a smaller particle size.

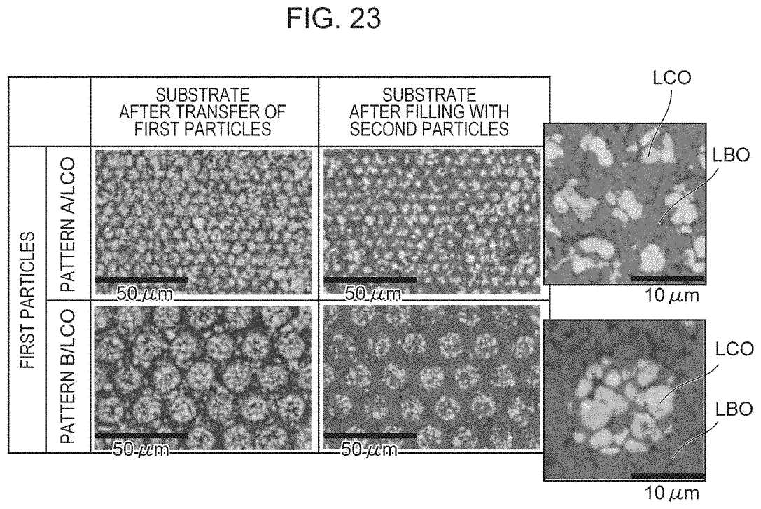

FIG. 23 shows SEM images of two types of substrates (pattern A and pattern B) in different patterns produced by the above method. An active material LiCoO₂ (CELLSEED C-5H manufactured by Nippon Chemical Industrial Co., Ltd., hereinafter referred to as LCO) as the first particles and a solid electrolyte Li₃BO₃ (manufactured by Toshima Manufacturing Co., Ltd., hereinafter referred to as LBO) as the second particles could be densely and desirably patterned. The pattern of the mold (the opening width and the period of the recessed portions, and the like) was designed so that the pattern A and the pattern B had almost the same density (mg/cm²) of the active material LCO.

Lamination and Degreasing

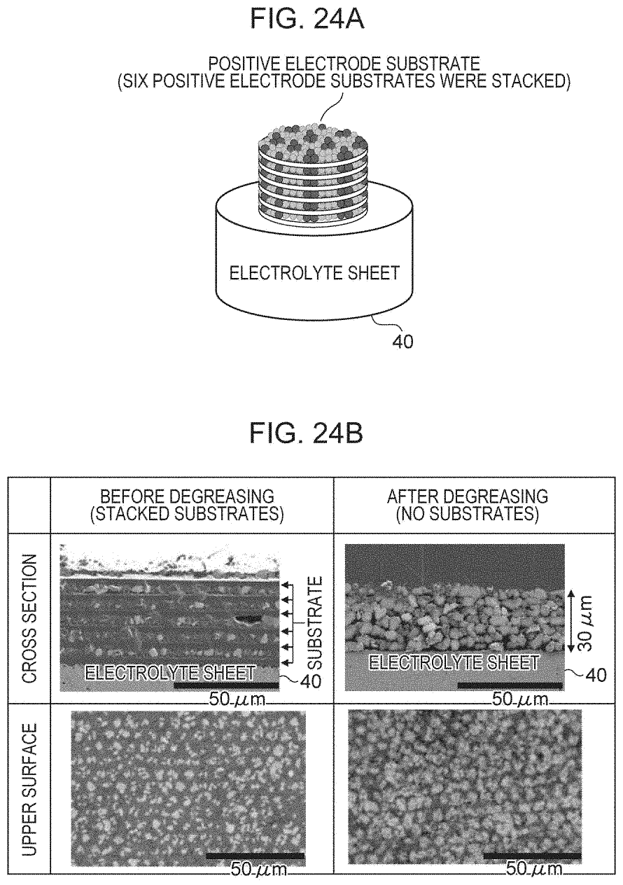

The anode substrate produced by the above patterning process was disposed on a solid electrolyte sheet. The solid electrolyte sheet was produced by uniaxially pressing and sintering (at 850° C. for 12 hours in the atmosphere) a solid electrolyte Li_{1.5}Al_{0.5}Ge_{1.5}(PO₄)₃ (manufactured by Toshima Manufacturing Co., Ltd., hereinafter referred to as LAGP). The electrolyte sheet had an ionic conductivity (25° C.) of 2.5×10⁻⁴ S/cm. FIG. 24A is a schematic view of the sample. Six anode substrates (pattern A/Φ8 mm) were stacked on a solid electrolyte sheet ( 11 mm) with a thickness of 260 μm and were pressed with an isostatic pressing apparatus. The substrate had an adhesive layer applied to the back surface thereof in the same manner as the front surface, and a plurality of the substrates could be stacked and fixed on the electrolyte sheet.

Next, the laminate was degreased in an electric furnace (at 300° C., 400° C., or 500° C. for one hour in the atmosphere). FIG. 24B shows cross-sectional/top SEM images before and after the degreasing step at 500° C. Degreasing at 500° C. removed the six PET substrates on the electrolyte sheet and formed a anode including six particle layers (film thickness: 30 μm). As shown in the top SEM image, the pattern on the substrate is maintained and formed. Although the positions of the substrate patterns are not aligned as illustrated in FIG. 24A, the active material LCO in the pattern A is sufficiently in contact with the solid electrolyte LBO in the plane, and the LBO has a mesh shape. Thus, it is thought that an ionic conduction path is easily formed in the in-plane direction and in the lamination direction.

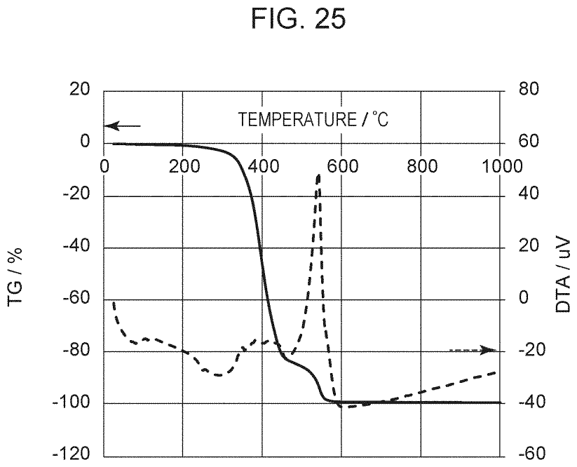

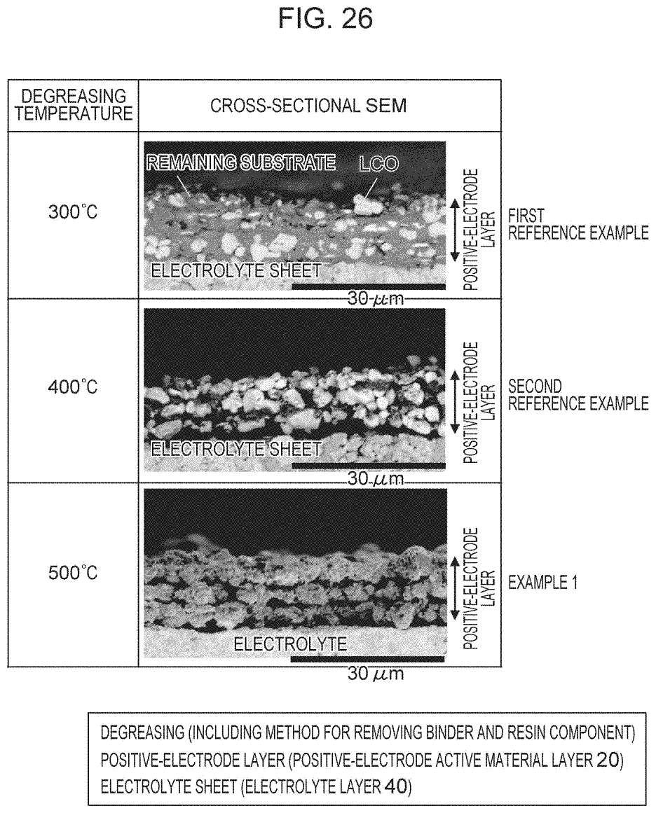

A change in the weight of the substrate was examined with a thermogravimetric-differential thermal analyzer (TG-DTA) (FIG. 25). The solid line is the TG curve (left axis), and the broken line is the DTA curve (right axis). The TG curve shows that the substrate disappears (−100%) at approximately 600° C. Another TG measurement under degreasing conditions showed that the substrate disappeared at 500° C. or more. FIG. 26 shows cross-sectional SEM images of the sample under the respective degreasing conditions. The 300° C. sample with the substrate remaining in TG (approximately 80% of the substrate remained) and the 400° C. sample with the substrate remaining in TG (approximately 20% of the substrate remained) also had a remaining substrate in the cross-sectional SEM images. On the other hand, the sample degreased at 500° C. had no substrate and contained only the active material and the solid electrolyte.

Preparation of all-Solid-State Battery

A method for producing an all-solid-state battery (secondary battery) is described below. A cathode In foil (manufactured by Nilaco Corporation, thickness: 50 μm) and current collectors for a anode and a cathode were stacked on the laminate from which the substrate was removed, were vacuum-packed in an Al laminated film (manufactured by Dai Nippon Printing Co., Ltd.), and were pressed with an isostatic pressing apparatus to produce a laminated battery. This production method corresponds to the steps S800, S840, and S860 in FIG. 18B.

<Evaluation of Battery Characteristics>

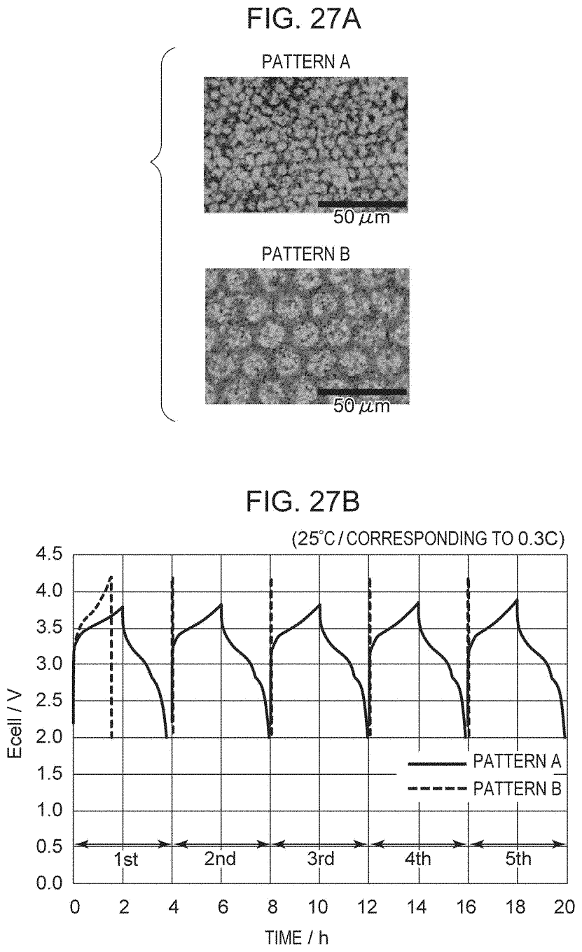

The results of verification of the battery characteristics of the secondary battery produced in the present example are described below with reference to FIGS. 27A to 29B.

Capacity Retention Rate Depending on Degreasing Temperature

In a method for evaluating the capacity retention rate, the total mass of lithium cobalt oxide LCO contained in the formed anode was determined from the LCO density of a anode substrate (pattern A/square 10 cm), and the capacity retention rate was measured with a charge-discharge apparatus at each rate at room temperature (25° C.). In the present specification, the degreasing includes the first heating step S340 and includes a method of removing a binder and a resin component.

As a result of testing a prototype battery, a prototype battery degreased at 300° C. or 400° C. had extremely high internal resistance (measurement results are not shown) and could not be charged beyond a cut-off value (4.2 V-2 V) even by constant-current charge corresponding to a rate of 0.05C. On the other hand, a prototype battery degreased at 500° C. was capable of constant-current charge-discharge corresponding to 0.3C and had a capacity retention rate of 97%.

Difference in Battery Characteristics Depending on Arrangement Pattern of Active Material Particles

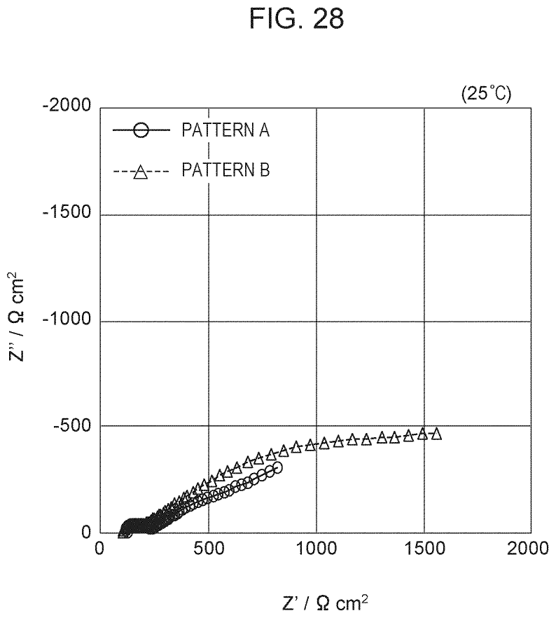

Two types of prototype batteries (pattern A and pattern B, three sheets were stacked in each pattern) were prepared (degreasing at 500° C. for one hour in the atmosphere), and the battery characteristics were evaluated. FIG. 27A shows a SEM image of each prototype battery, and FIG. 27B shows the results of constant-current charge-discharge measurement corresponding to 0.3C at room temperature (25° C.). The prototype battery of the pattern A could be charged and discharged for the set time (2 h), whereas the prototype battery of the pattern B exceeded the cut-off value (4.2 V-2 V) and could not be charged and discharged. FIG. 28 shows the results of the internal resistance of the batteries measured with an impedance apparatus after discharging.

This suggests that the prototype battery of the pattern B has higher resistance than the prototype battery of the pattern A, and this is considered to be the cause of the deterioration of the charge-discharge characteristics. The following causes can be considered for the difference in internal resistance. In the pattern A, the active material LCO is brought into contact with a solid electrolyte with a mesh-like network structure without aggregation, and an ionic conduction path is therefore easily formed in many LCO particles. On the other hand, in the pattern B, it is thought that the active material LCO aggregates and partly cannot come into contact with the surrounding solid electrolyte, so that it is difficult to form an ionic conduction path.

Battery Formation and Active Material Layer

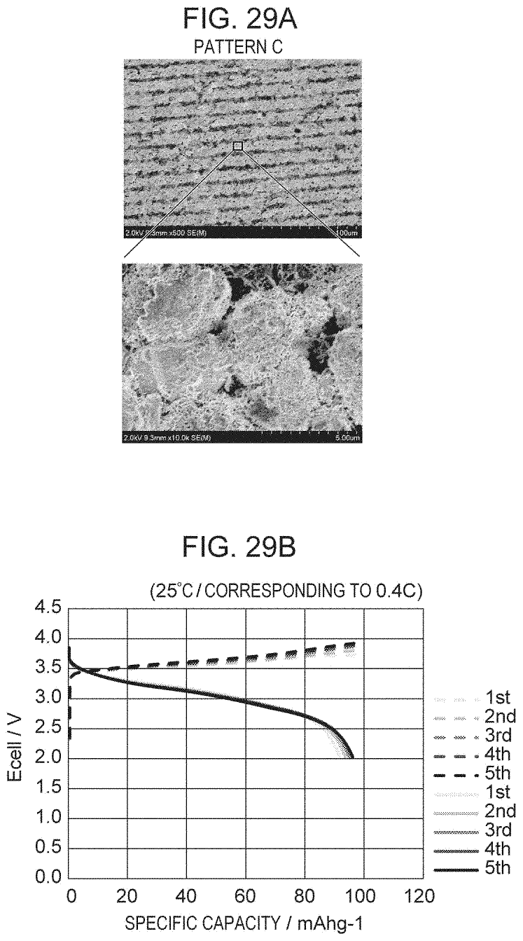

The arrangement pattern of the anode active material particles LCO and the anode internal electrolyte particles LBO in the anode active material layer included in the anode was a line-shaped pattern C (FIG. 29A). The pattern C had a line and space of 10 μm/4.3 μm (≈7:3) as LCO/LBO. A prototype secondary battery was produced that had a anode including three anode active material layers stacked such that the line directions of adjacent layers were not parallel to each other, that is, lines between layers crossed each other. The secondary battery was subjected to constant-current charge-discharge measurement corresponding to 0.4C at 25° C. FIG. 29B shows the results of the constant-current charge-discharge measurement. Crossing line patterns between adjacent anode active material layers can form a transport path of active material ions and electrons in the layer thickness direction of the anode and provide a anode with a low impedance.

The present invention can provide an active material particle that can cope with a decrease in the temperature of a battery production process and that can be used for a anode with high ionic conductivity. The present invention can also provide a secondary battery with good charge-discharge characteristics through a low-temperature production process by using an active material particle that does not excessively require high heat resistance.

The present application can also provide a anode with high ionic conductivity due to a reduced ion migration barrier between a anode active material and an electrolyte and with ensured flexibility in the arrangement of the anode active material, and provide a secondary battery including the anode.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. An active material particle that is applied to a anode containing a lithium cobalt oxide and that has a diffraction angle peak at an X-ray diffraction angle of 19.2 degrees or more and 19.7 degrees or less by a 2θ method.

2. The active material particle according to claim 1, having a plurality of diffraction angle peaks at X-ray diffraction angles of 19.2 degrees or more and 19.7 degrees or less.

3. The active material particle according to claim 1, further having a diffraction angle peak at an X-ray diffraction angle of 18.9 degrees or more and 19.1 degrees or less.

4. An active material particle that is applied to a anode containing a lithium cobalt oxide and that has a region with a crystallite size of 10 nm or more and 50 nm or less.

5. The active material particle according to claim 1, wherein the active material particle has a particle portion and a protrusion protruding from the particle portion in a plurality of directions.

6. The active material particle according to claim 5, wherein the protrusion has a region with a crystallite size of 1 nm or more and 20 nm or less.

7. The active material particle according to claim 5, wherein the particle portion has a core and a shell.

8. An anode comprising a surface on which active material particles according to claim 1 are arranged.

9. A secondary battery comprising:
the anode according to claim 8;
an electrolyte layer disposed in contact with the surface of the anode and configured to transfer a lithium ion to and from the active material particles; and
a cathode in contact with a surface of the electrolyte layer on an opposite side from the surface of the anode.

10. A anode comprising a surface on which active material particles according to claim 4 are arranged.

11. A secondary battery comprising:
the anode according to claim 10;
an electrolyte layer disposed in contact with the surface of the anode and configured to transfer a lithium ion to and from the active material particles; and
a cathode in contact with a surface of the electrolyte layer on an opposite side from the surface of the anode.

12. A method for producing an active material particle, comprising:
a first heating step of reducing at least part of cobalt contained in an active material particle containing a lithium cobalt oxide; and
a second heating step of oxidizing the reduced cobalt.

13. The method for producing an active material particle according to claim 12, wherein the first heating step includes a step of heating the active material particle in a reducing atmosphere containing a reducing gas.

14. The method for producing an active material particle according to claim 13, wherein the first heating step is performed until the reducing gas decreases and an atmosphere inside a furnace becomes an oxidizing atmosphere in which an oxidizing gas containing oxygen has higher partial pressure than the reducing gas.

15. The method for producing an active material particle according to claim 12, wherein the first heating step includes a step of reducing the cobalt from an oxidation number III to an oxidation number II.

16. The method for producing an active material particle according to claim 12, wherein the second heating step includes a step of oxidizing the cobalt from an oxidation number II to an oxidation number III.

17. The method for producing an active material particle according to claim 13, further comprising the step of disposing a resin for releasing the reducing gas by thermal decomposition in a furnace.

18. The method for producing an active material particle according to claim 17, wherein the reducing gas in the first heating step is supplied into the furnace by thermal decomposition of the resin.

19. The method for producing an active material particle according to claim 12, wherein the first heating step and the second heating step are performed such that an X-ray diffraction angle of the active material particle by a 2θ method is shifted to a high angle side.

20. The method for producing an active material particle according to claim 12, wherein the first heating step and the second heating step are performed so as to decrease a crystallite size of the active material particle.

21. A method for producing a anode, comprising the step of arranging a plurality of active material particles produced by the method according to claim 12 on a predetermined surface.

22. A method for producing a anode, comprising:
an arrangement step of arranging active material particles containing a lithium cobalt oxide on a predetermined surface;
a first heating step of reducing at least part of cobalt contained in the active material particles; and
a second heating step of oxidizing the reduced cobalt.

23. The method for producing a anode according to claim 22, wherein the first heating step is performed until a reducing gas derived from a resin decreases and an atmosphere inside a furnace becomes an oxidizing atmosphere in which an oxidizing gas containing oxygen has higher partial pressure than the reducing gas.

24. The method for producing a anode according to claim 22, wherein the first heating step includes a step of reducing the cobalt from an oxidation number III to an oxidation number II.

25. The method for producing a anode according to claim 22, wherein the second heating step includes a step of oxidizing the cobalt from an oxidation number II to an oxidation number III.

26. A method for producing a secondary battery, comprising the steps of:
a anode produced by the method for producing a anode according to claim 22;
disposing an electrolyte layer such that a lithium ion is transferred to and from the anode; and
disposing a current collector layer on an opposite side from the electrolyte layer such that a lithium ion is transferred to and from the anode.
